(19) United States
(12) Patent Application Publication
(10) Pub. No.: US 2020/0362083 A1
(43) Pub. Date: Nov. 19, 2020

(54) NOVEL COPOLYMER AND USE THEREOF AS A FUEL ADDITIVE

(71) Applicant: Total Marketing Services, Puteaux (FR)

(72) Inventors: Inigo Gonzalez, Lyon (FR); Julie Prevost, Lyon (FR)

(73) Assignee: Total Marketing Services, Puteaux (FR)

(21) Appl. No.: 16/762,834

(22) PCT Filed: Nov. 6, 2018
(86) PCT No.: PCT/EP2018/080257

§ 371 Date: May 8, 2020

(30) Foreign Application Priority Data
Nov. 10, 2017 (FR) 1760585

(51) Int. Cl. C08F 293/00; C10L 10/04; C10L 1/236; C08L 33/14; C08L 33/08; C08F 220/34; C08F 220/18; C08F 8/44

(52) U.S. Cl. CPC C08F 293/005; C10L 10/04; C10L 1/2366; C08L 33/14; C08L 33/08; C08F 220/34; C10L 2270/026; C08F 8/44; C08L 2203/40; C10L 2200/0446; C10L 2200/0423; C10L 2270/023; C08F 220/1808

(57) ABSTRACT

The invention relates to a copolymer comprising: at least one motif of the following formula (I), and motifs of the following formula (II), between 5 and 95 mol % of the groups R of the motifs of formula (II) comprising at least one quaternary amino group. The invention also relates to the production of such a copolymer, and to the use thereof as a detergent additive and/or demulsifying additive in a liquid fuel for an internal combustion engine.

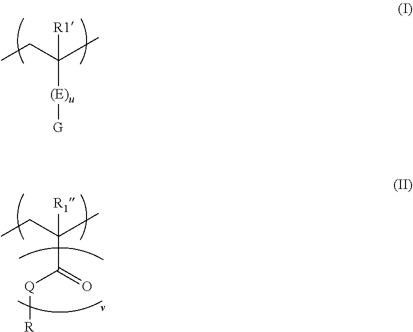

The present invention relates to a novel copolymer and to its use as additive for the liquid fuel of an internal combustion engine.

### PRIOR ART

Liquid fuels for internal combustion engines contain components that can degrade during the functioning of the engine. The problem of deposits in the internal parts of combustion engines is well known to motorists. It has been shown that the formation of these deposits has consequences on the performance of the engine and notably has a negative impact on consumption and particle emissions. Progress in the technology of fuel additives has made it possible to confront this problem. “Detergent” additives used in fuels have already been proposed to keep the engine clean by limiting deposits (“keep-clean” effect) or by reducing the deposits already present in the internal parts of the combustion engine (“clean-up” effect). Mention may be made, for example, of U.S. Pat. No. 4,171,959 which describes a detergent additive for gasoline fuel containing a quaternary ammonium function. WO 2006/135881 describes a detergent additive containing a quaternary ammonium salt used for reducing or cleaning deposits, notably on the inlet valves. However, engine technology is in constant evolution and the stipulations for fuels must evolve to keep pace with these technological advances of combustion engines. In particular, the novel gasoline or diesel direct-injection systems expose the injectors to more severe pressure and temperature conditions, which promotes the formation of deposits. In addition, these novel injection systems have more complex geometries to optimize the spraying, notably more numerous holes having smaller diameters, but which, on the other hand, induce greater sensitivity to deposits. The presence of deposits may impair the combustion performance and notably increase pollutant emissions and particle emissions. Other consequences of the excessive presence of deposits have been reported in the literature, such as the increase in fuel consumption and driveability problems.

Preventing and reducing deposits in these novel engines are essential for optimum functioning of modern engines. There is thus a need to propose detergent additives for fuel which promote optimum functioning of combustion engines, notably for modern engine technologies.

There is also a need for a universal detergent additive which is capable of acting on deposits irrespective of the engine technology and/or of the nature of the fuel.

Another important problem associated with liquid fuels for internal combustion engines is the presence of residual water within these fuels. Specifically, due to the process used for extracting crude oil but also because of the condensation of water within cold fuel during the transportation and storage thereof, fuels comprise a variable amount of water that may range from a few parts per million to a few percent by mass relative to the total mass of the fuel. The presence of this residual water generally leads to the formation of stable emulsions which, being suspended within the fuel, are the cause of numerous problems that arise during the transportation and/or combustion of these fuels. For example, these emulsions may cause obstruction of the engine filters or accelerate the corrosion of the engine.

The detergent additives currently used genuinely degrade the demulsifying of liquid fuels for internal combustion engines, in particular gas oils and gasolines.

In order to overcome these problems, it is common practice in the field of fuels to use demulsifying additives (or demulsifiers). These demulsifying additives then make it possible to break the water-in-fuel emulsions and to allow the separation of the water and of the fuel. As an example of a demulsifying additive composition, mention may be made of the one described in U.S. Pat. No. 4,219,508.

More recently, US 2016/0160144 proposes the use of a polyisobutenylsuccinic acid in combination with one or more detergent additives in order to improve the separation of water and fuel.

Numerous prior art documents describe the dehazing of fuels comprising water. This dehazing corresponds in reality to the stabilization of the water-in-fuel emulsion in order to obtain a fuel composition of one-phase appearance (emulsification). In contrast with demulsifying, dehazing does not allow the separation of water and fuel and therefore does not constitute a solution to the drawbacks described previously.

Consequently, there is still a need to propose an additive-based solution for giving fuels good detergent properties while at the same time maintaining or even improving the demulsifying of said fuel.

### SUBJECT OF THE INVENTION

The subject of the invention relates to novel copolymers comprising a combination of at least two particular types of units, as described below.

These copolymers are notably useful as additives in petroleum products, and in particular in liquid fuels for internal combustion engines.

The Applicant has discovered that the copolymers according to the invention have noteworthy properties as detergent additive in liquid fuels for internal combustion engines. The copolymers according to the invention used in these fuels make it possible to maintain the cleanliness of the engine, in particular by limiting or preventing the formation of deposits (“keep-clean” effect) or by reducing the deposits already present in the internal parts of the combustion engine (“clean-up” effect).

In addition, the copolymers according to the invention have noteworthy properties as demulsifying additive in liquid fuels for internal combustion engines. They specifically make it possible to improve the separation of the water and the fuel when said fuel contains water.

The term “improve the separation of the water and the fuel” means accelerating the separation, and/or increasing the degree of separation, of the fuel and of the residual water present in this fuel.

The additional advantages associated with the use of the copolymers according to the invention as fuel additives are:

optimum functioning of the engine,

reduction of the fuel consumption,

better driveability of the vehicle,

reduced emissions of pollutants, and

savings due to reduced engine maintenance.

The subject of the present invention is a copolymer comprising:

at least one unit of formula (I) below:

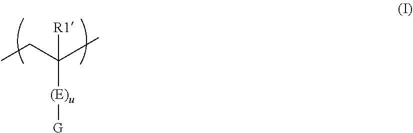

in which
u=0 or 1,
R₁′ represents a hydrogen atom or a methyl group,
E represents —O— or —N(Z)—, or —O—CO—, or —CO— or —NH—CO— or —CO—NH—, with Z representing H or a C₁ to C₆ alkyl group,
G represents a group chosen from a C₁ to C₃₄ alkyl group, an aromatic nucleus, an aralkyl group comprising at least one aromatic nucleus and at least one C₁ to C₃₄ alkyl group, and

units of formula (II) below:

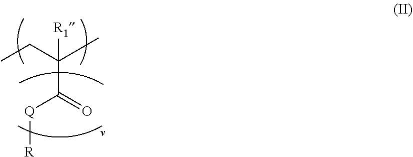

in which
v=0 or 1,
R₁″ is chosen from a hydrogen atom and a methyl group,
Q is chosen from an oxygen atom and a group —NR′— with R′ being chosen from a hydrogen atom and C₁ to C₁₂ hydrocarbon-based chains,
R represents a C₁ to C₃₄ hydrocarbon-based chain which may also contain one or more nitrogen and/or oxygen atoms and/or carbonyl groups, substituted with at least one non-quaternary amine group and/or at least one quaternary amine group,
said non-quaternary amine group comprising at least one primary, secondary or tertiary amine function,
said quaternary amine group comprising at least one quaternary ammonium function and optionally one or more hydroxyl groups,
5 mol % to 95 mol % of the groups R of the units of formula (II) comprising at least one quaternary amine group.

Preferentially, the group G of formula (I) is chosen from a C₁ to C₃₄ alkyl group, an aromatic nucleus, an aralkyl group comprising at least one aromatic nucleus and at least one C₁ to C₃₄ and preferably C₄ to C₃₄ alkyl group.

According to a first variant, the group G of formula (I) is an aralkyl group comprising at least one aromatic nucleus and at least one C₄ to C₃₀ alkyl group.

According to a second preferred variant, the group G of formula (I) is a C₄ to C₃₄ alkyl group.

According to a first embodiment, the group E of formula (I) is chosen from: —O— and —N(Z)—, with Z representing H or a C₁ to C₆ alkyl group.

According to a second embodiment, the group E of formula (I) is chosen from: —O—CO— and —NH—CO—; preferably, the group E is an —O—CO— group, it being understood that the group E=—O—CO— is connected to the vinyl carbon via the oxygen atom and that the group E=—NH—CO— is connected to the vinyl carbon via the nitrogen atom.

According to a third embodiment, the group E of formula (I) is chosen from: —CO— and —CO—NH—; preferably, the group E is a —CO—O— group, it being understood that the group E is connected to the vinyl carbon via the carbon atom.

As presented above, 5 mol % to 95 mol % of the groups R of the units of formula (II) comprise at least one quaternary amine group.

The units of formula (II) in which the group R does not comprise any quaternary amine groups comprise in the group R at least one amine group comprising a primary, secondary or tertiary amine function. These units represent from 5 mol % to 95 mol % of the units of formula (II) of the copolymer according to the invention.

According to a first variant, said non-quaternary amine group is chosen from groups containing at least one amine, imine, amidine, guanidine, aminoguanidine or biguanidine function, such as alkyl-amines, polyalkylene polyamines, polyalkyleneimines, alkyl-imines, alkyl-amidines, alkyl-guanidines and alkyl-biguanidines, the alkyl substituent possibly being linear or branched, cyclic or acyclic, and preferably containing from 1 to 34 carbon atoms, more preferentially from 1 to 12 carbon atoms.

According to a second variant, said non-quaternary amine group is chosen from monocyclic or polycyclic heterocyclic groups, containing from 3 to 34 atoms, preferably from 5 to 12 atoms, more preferentially from 6 to 10 atoms, and at least one nitrogen atom, it being understood that the polycyclic heterocyclic groups optionally contain fused rings. The number of atoms includes the heteroatoms. The term “fused rings” means rings containing at least two atoms in common. The heterocyclic groups may also comprise an oxygen atom and/or a carbonyl group and/or one or more unsaturations.

Examples of heterocyclic amine groups that may be mentioned include the following radicals: triazole, aminotriazole, pyrrolidone, piperidine imidazole, morpholine, isoxazole, oxazole, indole, said radical preferably being connected to the hydrocarbon-based chain via a nitrogen atom.

According to a preferred embodiment, the group R of formula (II) comprising at least one non-quaternary amine group is represented:

when v is equal to 1, by formula (V):

L-R′₂— (V)

when v is equal to 0, by formula (V) or by formula (V′):

L-R′₂— (V)

L- (V′)

in which formulae (V) and (V′):

R₂′ is chosen from C₁ to C₃₄ hydrocarbon-based chains, optionally substituted with at least one hydroxyl group, and

L is chosen from the group consisting of:

the following groups:

amine: —NH₂; —NHRₐ; —NRₐR_{b};

imine: —HC═NH; —HC═NRₐ; —N═CH₂; N═CRₐH; —N═CRₐR_{b};

amidine: —(C═NH)—NH₂: —(C═NH)—NRₐH; —(C═NH)—NRₐR_{b}; —(C═NRₐ)—NH₂; —(C═NRₐ)—NR_{b}H; —(C═NRₐ)—NR_{b}R_{c}; —N═CH(NH₂); —N═CRₐ (NH₂); —N═CH(NRₐH); —N═CRₐ(NRₐH); —N═CH(NRₐR_{b}); —N═CRₐ (NR_{b}R_{c});

guanidine: —NH—(C═NH)—NH₂; —NH—(C═NH)—NHRₐ; —N═C(NH₂)₂; —N═C(NRₐH)₂; —N═C(NRₐR_{b})₂; —N═C(NRₐH)(NR_{b}H);

aminoguanidine: —NH—(C═NH)—NH—NH₂; —NH—(C═NH)—NH—NHRₐ; —N═C(NH₂)(NH—NH₂); —N═C(NRₐH)(NH—NH₂); —N═C(NRₐR_{b})(NH—NH₂); —N═C(NRₐR_{b})(NRₐ—NH₂; —N═C(NRₐR_{b}) (NRₐ—NH₂);

biguanidine: —NH—(C═NH)—NH—(C═NH)—NH₂; —NH—(C═NH)—NH—(C═NH)—NHRₐ; —N═C(NH₂)—NH—(C═NH)—NH₂; —N═C(NH₂)—NH—(C═NRₐ)—NH₂; —N═C(NH₂)—NH—(C═NH)—NRₐH; —N═C(NH₂)—NH—(C═NRₐ)—NR_{b}H; —N═C(NH₂)—NH—(C═NH)—NRₐR_{b}; —N═C(NH₂)—NH—(C═NRₐ)—NR_{b}R_{c}; —N═C(NRₐH)—NH—(C═NH)—NH₂; —N═C(NRₐH)—NH—(C═NR_{b})—NH₂; —N═C(NRₐH)—NH—(C═NH)—NR_{b}H; —N═C(NRₐH)—NH—(C═NR_{b})—NR_{c}H; —N═C(NRₐH)—NH—(C═NH)—NR_{b}R_{c}; —N═C(NRₐH)—NH—(C═NR_{b})—NR_{c}R_{d}; —N═C(NRₐR_{b})—NH—(C═NH)—NH₂; —N═C(NRₐR_{b})—NH—(C═NR_{c})—NH₂; —N═C(NRₐR_{b})—NH—(C═NH)—NR_{c}H; —N═C(NRₐR_{b})—NH—(C═NR_{c})—NR_{d}H; —N═C(NRₐR_{b})—NH—(C═NH)—NR_{c}R_{d}; —N═C(NRₐR_{b})—NH—(C═NR_{c})—NR_{d}Rₑ; and

polyamine and polyalkylene-polyamine groups, notably those of formulae —NH—(R_{f}—NH)ₖ—H; —NH—(R_{f}—NH)ₖ— Rₐ;

with Rₐ, R_{b}, R_{c}, R_{d} and Rₑ representing, independently of each other, a C₁-C₃₄ and preferably C₁-C₁₂ alkyl group, optionally comprising one or more NH₂ functions and one or more —NH— bridges;

R_{f} represents a C₁-C₆ and preferably C₂-C₄ alkyl group, and k represents an integer ranging from 1 to 20 and preferably from 2 to 12.

Examples of polyamine and polyalkylene-polyamine groups that may be mentioned include: ethylenediamine, diethylenetriamine, triethylenetetramine, tetraethylenepentamine.

The quaternary ammonium function(s) of the quaternary amine group may be chosen from pyrrolinium, pyridinium, imidazolium, triazolium, triazinium, oxazolium and isoxazolium quaternary ammoniums.

According to one variant, the quaternary ammonium function(s) are chosen from trialkylammonium, iminium, amidinium, formamidinium, guanidinium and biguanidinium quaternary ammoniums, and preferably trialkylammonium quaternary ammoniums.

According to a preferred embodiment, the group R of formula (II) comprising at least one quaternary amine group is a quaternized form of one of the groups of formulae (V) and (V′) above, when they contain at least one quaternizable nitrogen atom.

According to a particularly preferred embodiment, the group R of formula (II) comprising at least one quaternary amine group is represented by one of the formulae (III) and (IV) below:

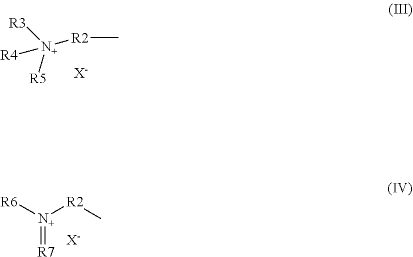

in which

X⁻ is chosen from hydroxide and halide ions and organic anions, preferably organic anions,

R₂ is chosen from C₁ to C₃₄ hydrocarbon-based chains, optionally substituted with at least one hydroxyl group,

R₃, R₄ and R₅ are identical or different and chosen independently from C₁ to C₁₈ hydrocarbon-based chains, it being understood that the groups R₃, R₄ and R₅ may contain one or more groups chosen from: a nitrogen atom, an oxygen atom and a carbonyl group and that the groups R₃, R₄ and R₅ may be connected together in pairs to form one or more rings,

R₆ and R₇ are identical or different and chosen independently from C₁ to C₁₈ hydrocarbon-based chains, it being understood that the groups R₆ and R₇ may contain one or more groups chosen from: a nitrogen atom, an oxygen atom and a carbonyl group and that the groups R₆ and R₇ may be connected together to form a ring.

According to a particularly preferred embodiment, the group R of formula (II) comprising at least one quaternary amine group is represented by formula (III) above, in which:

X⁻ chosen from organic anions, preferably conjugate bases of carboxylic acids,

R₂ is chosen from C₁ to C₃₄ hydrocarbon-based chains, preferably C₁ to C₁₈ alkyl groups,

R₃, R₄ and R₅ are identical or different and chosen independently from C₁ to C₁₈ hydrocarbon-based chains, optionally substituted with at least one hydroxyl group, it being understood that at least one of the groups R₃, R₄ and R₅ contains one or more hydroxyl groups.

A subject of the present invention is also a process for preparing the copolymer as described above.

According to a first embodiment, the copolymer according to the invention is obtained by copolymerization of at least:

one apolar monomer (mₐ) corresponding to formula (VII) below:

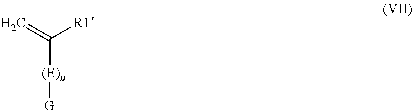

in which
R₁′, u, E and G are as defined above, and

polar monomers (m) corresponding to formula (VIII) below:

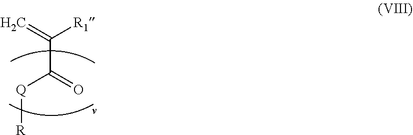

in which
R₁″, v, Q and R are as defined above,
it being understood that 5 mol % to 95 mol % of the polar monomers (m_{b}) comprise a group R containing at least one quaternary amine group.

According to a second embodiment, the copolymer according to the invention is obtained by copolymerization of at least:

one apolar monomer (mₐ) corresponding to formula (VII) below:

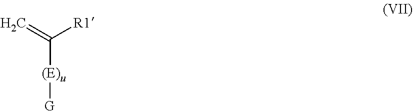

in which
R₁′, u, E and G are as defined above, and

one polar monomer (m_{b}) corresponding to formula (VIII) below:

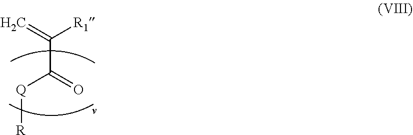

in which
R₁″, y and Q are as defined above,
and R represents a C₁ to C₃₄ hydrocarbon-based chain which may also contain one or more nitrogen and/or oxygen atoms and/or carbonyl groups, substituted with at least one non-quaternary amine group,

the copolymerization being followed by partial quaternization of the amine groups of the units derived from the monomer (m_{b}).

The term “partial quaternization” means quaternization of 5 mol % to 95 mol % of the amine groups of the units derived from the monomer (m_{b}). This quaternization of said amine groups implies that they comprise at least one quaternizable nitrogen atom.

According to a preferred embodiment, the monomer (mₐ). is chosen from C₁ to C₃₄ alkyl acrylates and C₁ to C₃₄ alkyl methacrylates.

According to a preferred embodiment, the copolymer according to the invention is chosen from block copolymers and statistical copolymers, and preferably the copolymer according to the invention is a block copolymer.

Preferably, the copolymer according to the invention is a block copolymer comprising:

a block A corresponding to formula (XI) below:

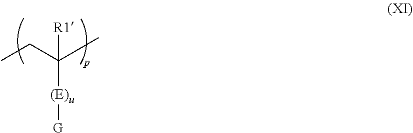

in which
p is an integer ranging from 2 to 100, preferably ranging from 5 to 80, preferably ranging from 10 to 70, more preferentially ranging from 20 to 60,
R₁′, u, E and G are as defined above, and

a block B corresponding to formula (XII) below:

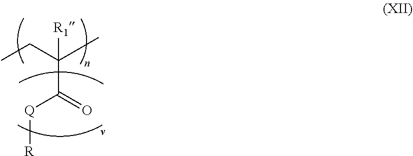

in which
n is an integer ranging from 2 to 50, preferably from 3 to 40, more preferentially from 4 to 20, even more preferentially from 5 to 10,
R₁″, v, Q and R are as defined above,
it being understood that 5 mol % to 95 mol % of the units of block B comprise a group R containing at least one quaternary amine group.

Preferably, the block copolymer comprises at least:

one block A consisting of a chain of structural units derived from one or more apolar monomers chosen from the apolar monomers (mₐ) of formula (VII), and

one block B consisting of a chain of structural units derived from polar monomers chosen from the polar monomers (m_{b}) of formula (VIII).

More preferentially, the block copolymer comprises at least:

block A consisting of a chain of structural units derived from a single apolar monomer chosen from the apolar monomers (mₐ) of formula (VII), and

block B consisting of a chain of structural units, of which 5 mol % to 95 mol % are derived from a single polar monomer chosen from the polar monomers (m_{b}) of formula (VIII) in which the group R contains at least one quaternary amine group, and of which 5 mol % to 95 mol % are derived from a single polar monomer chosen from the polar monomers (m_{b}) of formula (VIII) in which the group R does not contain any quaternary amine groups and comprises at least one non-quaternary amine group.

Even more preferentially, the block copolymer comprises at least:

block A consisting of a chain of structural units derived from a C₁-C₃₄ alkyl (meth)acrylate monomer (mₐ), and

block B consisting of a chain of structural units derived from alkyl (meth)acrylate or alkyl(meth)acrylamide monomers (m_{b}), of which 5 mol % to 95 mol % have an alkyl radical consisting of a C₁ to C₃₄ hydrocarbon-based chain substituted with a quaternary amine group and optionally one or more hydroxyl groups, and of which 5 mol % to 95 mol % have an alkyl radical consisting of a C₁ to C₃₄ hydrocarbon-based chain substituted with a non-quaternary amine group chosen from primary, secondary and tertiary amines, preferably tertiary amines.

Preferably, the number of equivalents of monomer (mₐ) of the block A is from 2 to 100 mol.

Preferably, the number of equivalents of monomer (m_{b}) of the block B is from 2 to 50 mol.

Preferably, the copolymer comprises at least one sequence of blocks AB, ABA or BAB in which said blocks A and B form a sequence without the presence of an intermediate block of different chemical nature.

Preferentially, the block copolymer is obtained by sequenced polymerization, preferably followed by one or more post-functionalizations.

The invention also relates to a concentrate for fuel, comprising one or more copolymers according to the invention as defined above, as a mixture with an organic liquid, said organic liquid being inert with respect to said copolymer(s), and miscible with said fuel.

The invention also relates to a fuel composition comprising:

(1) a fuel derived from one or more sources chosen from the group consisting of mineral, animal, plant and synthetic sources, and

(2) one or more copolymers as described previously.

Preferably, the fuel composition according to the invention comprises the copolymer(s) according to the invention in a minimum content of 5 ppm.

Preferably, the fuel (1) is chosen from hydrocarbon-based fuels, fuels that are not essentially hydrocarbon-based, and mixtures thereof.

Advantageously, the hydrocarbon-based fuel is chosen from gasolines and gas oils, also known as diesel fuel.

The invention also relates to the use of a copolymer as described previously, as detergent additive in a liquid fuel for internal combustion engines, said copolymer being used alone or in the form of a concentrate as defined previously.

According to a particular embodiment, said copolymer is used in the liquid fuel for keeping clean and/or cleaning at least one of the internal parts of said internal combustion engine.

According to a particular embodiment, said copolymer is used in the liquid fuel for limiting or preventing the formation of deposits in at least one of the internal parts of said engine and/or for reducing the existing deposits in at least one of the internal parts of said engine.

Advantageously, the deposits are located in at least one of the internal parts chosen from the engine intake system, the combustion chamber and the fuel injection system.

According to a particular embodiment, said copolymer is used in the liquid fuel for reducing the fuel consumption of the internal combustion engine.

According to a particular embodiment, said copolymer is used for reducing the pollutant emissions, in particular the particle emissions of the internal combustion engine.

According to a particular embodiment, the internal combustion engine is a spark ignition engine.

According to another particular embodiment, the internal combustion engine is a diesel engine, preferably a direct-injection diesel engine.

Advantageously, the copolymer is used for preventing and/or reducing the formation of deposits in the injection system of a diesel engine.

In particular, the copolymer is used for preventing and/or reducing the formation of deposits associated with coking and/or deposits of soap and/or lacquer type.

The invention also relates to the use of a copolymer as described previously, as demulsifying additive in a liquid fuel for internal combustion engines, said copolymer being used alone or in the form of a concentrate as defined previously.

According to a particular embodiment, the copolymer is used in the liquid fuel for accelerating the separation, and/or increasing the degree of separation, of the fuel and the residual water that may be present in this fuel.

The invention also relates to a process for keeping clean and/or for cleaning at least one of the internal parts of an internal combustion engine, comprising at least the following steps:

the preparation of a fuel composition by supplementing a fuel with a copolymer as described above or with a concentrate as described above, and then

the combustion of said fuel composition in said internal combustion engine.

Finally, the invention relates to a process for demulsifying a fuel containing water, or for separating the water from a fuel containing same. This process comprises at least the following steps:

the preparation of a fuel composition by supplementing a fuel with a copolymer as described above or with a concentrate as described above, and then

the separation of the water and the fuel.

### DETAILED DESCRIPTION

Other advantages and features will emerge more clearly from the description that follows. The particular embodiments of the invention are given as nonlimiting examples.

For the sake of simplicity, the following terms are used in the present description:

“alkyl (meth)acrylate” to denote an alkyl acrylate or an alkyl methacrylate;

“alkyl(meth)acrylamide” to denote an alkylacrylamide or an alkylmethacrylamide; and

“quaternary ammonium” to denote a quaternary ammonium salt.

The copolymer:

The invention relates to a copolymer comprising:

at least one unit of formula (I) below:

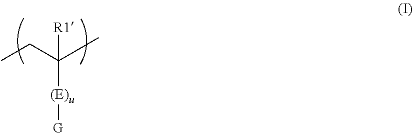

in which
u=0 or 1,
R₁′ represents a hydrogen atom or a methyl group,
E represents —O— or —N(Z)—, or —O—CO—, or —CO— or —NH—CO— or —CO—NH—, with Z representing H or a C₁ to C₆ alkyl group,
G represents a group chosen from a C₁ to C₃₄ alkyl group, an aromatic nucleus, an aralkyl group comprising at least one aromatic nucleus and at least one C₁ to C₃₄ alkyl group, and

units of formula (II) below:

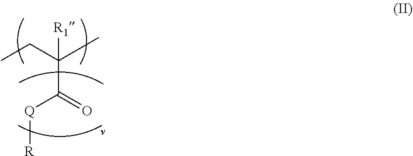

in which
v=0 or 1,
R₁″ is chosen from a hydrogen atom and a methyl group,
Q is chosen from an oxygen atom and a group —NR′— with R′ being chosen from a hydrogen atom and C₁ to C₁₂ hydrocarbon-based chains,
R represents a C₁ to C₃₄ hydrocarbon-based chain which may also contain one or more nitrogen and/or oxygen atoms and/or carbonyl groups, substituted with at least one non-quaternary amine group and/or at least one quaternary amine group,
said non-quaternary amine group comprising at least one primary, secondary or tertiary amine function,
said quaternary amine group comprising at least one quaternary ammonium function and optionally one or more hydroxyl groups,
5 mol % to 95 mol % of the groups R of the units of formula (II) comprising at least one quaternary amine group.

According to a particular embodiment, the copolymer comprises only units of formula (I) and units of formula (II).

According to a particular embodiment, the copolymer is chosen from block copolymers and statistical copolymers.

According to a particularly preferred embodiment, the copolymer is a block copolymer.

According to a first variant, the unit of formula (I) is chosen from those complying with u=0.

Preferentially, and according to this first variant, the copolymer is a block copolymer.

According to another variant, the unit of formula (I) is chosen from those complying with u=1.

The group E of formula (I) is chosen from:
E=—O—,
E=—N(Z)— with Z representing H or a linear or branched, cyclic or acyclic, preferably acyclic, C₁ to C₆ alkyl group,
E=—O—CO—, it being understood that E is then connected to the vinyl carbon via the oxygen atom,
E=—CO—O—, it being understood that E is then connected to the vinyl carbon via the carbon atom,
E=—NH—CO—, and
E=—CO—NH—.

According to a first embodiment, the group E of formula (I) is chosen from: —O— and —N(Z)—, with Z representing H or a C₁ to C₆ alkyl group.

According to a second embodiment, the group E of formula (I) is chosen from: —O—CO— and —NH—CO—, it being understood that the group E=—O—CO— is connected to the vinyl carbon via the oxygen atom and that the group E=—NH—CO— is connected to the vinyl carbon via the nitrogen atom.

According to this same embodiment, the group E of formula (I) is preferably the —O—CO— group, it being understood that the —O—CO— group is connected to the vinyl carbon via the oxygen atom.

According to a third embodiment, the group E of formula (I) is chosen from: —CO—O— and —CO—NH—, it being understood that the group E is connected to the vinyl carbon via the carbon atom.

According to this same third embodiment, the group E of formula (I) is preferably the —CO—O— group, it being understood that the —CO—O— group is connected to the vinyl carbon via the carbon atom.

According to a preferred embodiment, the unit of formula (I) is such that u=1 and the group E is a —CO—O— group, E being connected to the vinyl carbon via the carbon atom.

The group (G) of formula (I) may be a C₁ to C₃₄ alkyl group, preferably a C₄ to C₃₄, preferably C₄ to C₃₀, more preferentially C₆ to C₂₄ and even more preferentially C₈ to C₁₈ alkyl radical. The alkyl radical is a linear or branched, cyclic or acyclic, preferably acyclic, radical. This alkyl radical may comprise a linear or branched part and a cyclic part.

The group (G) of formula (I) is advantageously an acyclic C₁ to C₃₄ alkyl, preferably a C₄ to C₃₄, preferably C₄ to C₃₀, more preferentially C₆ to C₂₄ and even more preferentially C₈ to C₁₈ alkyl radical, which is linear or branched, preferably branched.

Mention may be made, nonlimitingly, of alkyl groups such as butyl, octyl, decyl, dodecyl, 2-ethylhexyl, isooctyl, isodecyl and isododecyl.

The group (G) of formula (I) may also be an aromatic nucleus, preferably a phenyl or aryl group. Among the aromatic groups, mention may be made, nonlimitingly, of the phenyl or naphthyl group, preferably the phenyl group.

The group (G) of formula (I) may, according to another preferred variant, be an aralkyl comprising at least one aromatic nucleus and at least one C₁ to C₃₄ alkyl group. Preferably, according to this variant, the group (G) is an aralkyl comprising at least one aromatic nucleus and one or more C₄ to C₃₄, preferably C₄ to C₃₀, more preferentially C₆ to C₂₄ and even more preferentially C₈ to C₁₈ alkyl groups.

The aromatic nucleus may be monosubstituted or substituted on several of its carbon atoms. Preferably, the aromatic nucleus is monosubstituted.

The C₁ to C₃₄ alkyl group may be in the ortho, meta or para position on the aromatic nucleus, preferably in the para position.

The alkyl radical is a linear or branched, cyclic or acyclic, preferably acyclic, radical.

The alkyl radical is preferably a linear or branched, preferably branched, acyclic radical.

The aromatic nucleus may be directly connected to the group E or to the vinyl carbon, but it may also be connected thereto via an alkyl substituent.

Examples of groups G that may be mentioned include a benzyl group substituted in the para position with a C₄-C₃₄ and preferably C₄-C₃₀ alkyl group.

Preferably, according to this variant, the group (G) of formula (I) is an aralkyl comprising at least one aromatic nucleus and at least one C₄ to C₃₄, preferably C₄ to C₃₀, more preferentially C₆ to C₂₄ and even more preferentially C₈ to C₁₈ alkyl group.

According to a particular embodiment, the group Q of formula (II) is an oxygen atom.

For 5 mol % to 95 mol % of the units of formula (II), the group R comprises at least one quaternary amine group.

According to a preferred embodiment, 10 mol % to 90 mol % of the groups R of the units of formula (II) comprise at least one quaternary amine group, more preferentially from 20% to 80%, even more preferentially from 40% to 60% and better still from 45% to 55% relative to the total amount of groups R of the units of formula (II).

Furthermore, the units of formula (II) in which the group R does not comprise any quaternary amine groups comprise at least one non-quaternary amine group comprising at least one primary, secondary or tertiary amine function.

These units represent from 5 mol % to 95 mol % of the units of formula (II) of the copolymer according to the invention, preferably from 10 mol % to 90 mol %, more preferentially from 20% to 80 mol %, even more preferentially from 40 mol % to 60 mol % and better still from 45 mol % to 55 mol %.

According to a first variant, said non-quaternary amine group is chosen from groups containing at least one amine, imine, amidine, guanidine, aminoguanidine or biguanidine function, such as alkyl-amines, polyalkylene polyamines, polyalkyleneimines, alkyl-imines, alkyl-amidines, alkyl-guanidines and alkyl-biguanidines, the alkyl substituent possibly being linear or branched, cyclic or acyclic, and preferably containing from 1 to 34 carbon atoms, more preferentially from 1 to 12 carbon atoms.

According to a second variant, said non-quaternary amine group is chosen from monocyclic or polycyclic heterocyclic groups, containing from 3 to 34 atoms, preferably from 5 to 12 atoms, more preferentially from 6 to 10 atoms, and at least one nitrogen atom, it being understood that the polycyclic heterocyclic groups optionally contain fused rings. The number of atoms includes the heteroatoms. The term “fused rings” means rings containing at least two atoms in common. The heterocyclic groups may also comprise an oxygen atom and/or a carbonyl group and/or one or more unsaturations.

Examples of heterocyclic amine groups that may be mentioned include the following radicals: triazole, aminotriazole, pyrrolidone, piperidine imidazole, morpholine, isoxazole, oxazole, indole, said radical preferably being connected to the hydrocarbon-based chain via a nitrogen atom.

According to a preferred embodiment, the group R comprising at least one non-quaternary amine group is represented:

when v is equal to 1, by formula (V) below:

L-R′₂— (V)

when v is equal to 0, by one of the formulae (V) and (V′) below:

L-R′₂— (V)

L- (V′)

in which formulae (V) and (V′):

R₂′ is chosen from cyclic or acyclic, linear or branched C₁ to C₃₄, preferably C₁ to C₁₈, more preferentially C₁ to C₈ and even more preferentially C₂ to C₄ hydrocarbon-based chains, optionally substituted with at least one hydroxyl group; preferably, R₂′ is chosen from alkyl groups, optionally substituted with at least one hydroxyl group; and

L is chosen from the group consisting of:

the following groups:

amine: —NH₂; —NHRₐ; —NRₐR_{b};

imine: —HC═NH; —HC═NRₐ; —N═CH₂; N═CRₐH; —N═CRₐR_{b};

amidine: —(C═NH)—NH₂; —(C═NH)—NRₐH; —(C═NH)—NRₐR_{b}; (C═NRₐ)—NH₂; —(C═NRₐ)—NR_{b}H; —(C═NRₐ)—NR_{b}R_{c}; —N═CH(NH₂); —N═CRₐ (NH₂); —N═CH(NRₐH); —N═CRₐ(NRₐH); —N═CH(NRₐR_{b}); —N═CRₐ (NR_{b}R_{c});

guanidine: —NH—(C═NH)—NH₂; —NH—(C═NH)—NHRₐ; —N═C(NH₂)₂; —N═C(NRₐH)₂; —N═C(NRₐR_{b})₂; —N═C(NRₐH)(NR_{b}H);

aminoguanidine: —NH—(C═NH)—NH—NH₂; —NH—(C═NH)—NH—NHRₐ; —N═C(NH₂)(NH—NH₂); —N═C(NRₐH)(NH—NH₂); —N═C(NRₐR_{b})(NH—NH₂); —N═C(NRₐR_{b})(NRₐ—NH₂; —N═C(NRₐR_{b}) (NRₐ—NH₂);

biguanidine: —NH—(C═NH)—NH—(C═NH)—NH₂; —NH—(C═NH)—NH—(C═NH)—NHRₐ; —N═C(NH₂)—NH—(C═NH)—NH₂; —N═C(NH₂)—NH—(C═NRₐ)—NH₂; —N═C(NH₂)—NH—(C═NH)—NRₐH; —N═C(NH₂)—NH—(C═NRₐ)—NR_{b}H; —N═C(NH₂)—NH—(C═NH)—NRₐR_{b}; —N═C(NH₂)—NH—(C═NRₐ)—NR_{b}R_{c}; —N═C(NRₐH)—NH—(C═NH)—NH₂; —N═C(NRₐH)—NH—(C═NR_{b})—NH₂; —N═C(NRₐH)—NH—(C═NH)—NR_{b}H; —N═C(NRₐH)—NH—(C═NR_{b})—NR_{c}H; —N═C(NRₐH)—NH—(C═NH)—NR_{b}R_{c}; —N═C(NRₐH)—NH—(C═NR_{b})—NR_{c}R_{d}; —N═C(NRₐR_{b})—NH—(C═NH)—NH₂; —N═C(NRₐR_{b})—NH—(C═NR_{c})—NH₂; —N═C(NRₐR_{b})—NH—(C═NH)—NR_{c}H; —N═C(NRₐR_{b})—NH—(C═NR_{c})—NR_{d}H; —N═C(NRₐR_{b})—NH—(C═NH)—NR_{c}R_{d}; —N═C(NRₐR_{b})—NH—(C═NR_{c})—NR_{d}Rₑ, and

polyamine and polyalkylene-polyamine groups, notably those of formulae —NH—(R_{f}—NH)ₖ—H; —NH—(R_{f}—NH)ₖ— Rₐ;

with Rₐ, R_{b}, R_{c}, R_{d} and Rₑ representing, independently of each other, a C₁-C₃₄ and preferably C₁-C₁₂ alkyl group, optionally comprising one or more NH₂ functions and one or more —NH— bridges;

R_{f} representing a C₁-C₆ and preferably C₂-C₄ alkyl group, and k represents an integer ranging from 1 to 20 and preferably from 2 to 12.

Examples of polyamine and polyalkylene-polyamine groups that may be mentioned include: ethylenediamine, diethylenetriamine, triethylenetetramine, tetraethylenepentamine.

According to a particular embodiment, v is equal to 0. In this embodiment, preferably, the group R comprising at least one non-quaternary amine group is represented by formula (V′):

L- (V′)

L being as defined above.

According to a particular embodiment, the group R₂′ is chosen from linear or branched C₁ to C₃₄, preferably C₁ to C₁₈, more preferentially C₁ to C₈ and even more preferentially C₂ to C₄ acyclic alkyl groups, and which may be substituted with at least one hydroxyl group.

According to a particularly preferred embodiment, the group R comprising at least one non-quaternary amine group is represented by formula (V) in which L is chosen from the following groups: —NH₂; —NHRₐ, —NRₐR_{b}, with Rₐ and R_{b} as defined above, and more preferentially from tertiary amine groups —NRₐR_{b}.

According to a preferred embodiment, the group R of formula (II) comprising at least one quaternary amine group is a quaternized form of one of the groups of formulae (V) and (V′) above, when they contain at least one quaternizable nitrogen atom.

The quaternary amine group may be obtained in particular by quaternization of at least one amine, imine, amidine, guanidine, aminoguanidine or biguanidine function; or alternatively of a heterocyclic group containing from 3 to 34 atoms and at least one nitrogen atom; and preferably by quaternization of tertiary amine functions.

According to a particular embodiment, the group R comprising at least one quaternary amine group is represented by one of the formulae (III) and (IV) below:

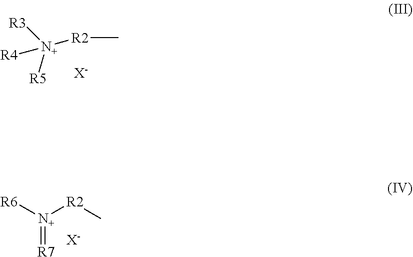

in which

X⁻ is chosen from hydroxide and halide ions and organic anions, in particular the acetate ion,

R₂ is chosen from cyclic or acyclic, linear or branched C₁ to C₃₄, preferably C₁ to C₁₈, more preferentially C₁ to C₈ and even more preferentially C₂ to C₄ hydrocarbon-based chains, optionally substituted with at least one hydroxyl group; preferably, R₂ is chosen from alkyl groups, optionally substituted with at least one hydroxyl group,

R₃, R₄ and R₅ are identical or different and chosen independently from linear or branched, cyclic or acyclic C₁ to C₁₈ and preferably C₁ to C₁₂ hydrocarbon-based chains, it being understood that the alkyl groups R₃, R₄ and R₅ may contain one or more nitrogen and/or oxygen atoms and/or carbonyl groups and may be connected together in pairs to form one or more rings,

R₆ and R₇ are identical or different and chosen independently from linear or branched, cyclic or acyclic C₁ to C₁₈ and preferably C₁ to C₁₂ hydrocarbon-based chains, it being understood that the groups R₆ and R₇ may contain one or more nitrogen and/or oxygen atoms and/or carbonyl groups and may be connected together to form a ring.

The nitrogen and/or oxygen atom(s) may be present in the groups R₃, R₄ and R₅ in the form of ether bridges or amine bridges or in the form of an amine or hydroxyl substituent.

The organic anions of the group X⁻ are advantageously conjugate bases of organic acids, preferably conjugate bases of carboxylic acids, in particular acids chosen from cyclic or acyclic monocarboxylic and polycarboxylic acids. Preferably, the organic anions of the group X⁻ are chosen from conjugate bases of saturated acyclic or aromatic cyclic carboxylic acids. Examples that will be mentioned include methanoic acid, acetic acid, adipic acid, oxalic acid, malonic acid, succinic acid, citric acid, benzoic acid, phthalic acid, isophthalic acid and terephthalic acid.

According to a particular embodiment, the group R₂ is chosen from linear or branched C₁ to C₃₄, preferably C₁ to C₁₈, more preferentially C₁ to C₈ and even more preferentially C₂ to C₄ acyclic alkyl groups, substituted with at least one hydroxyl group.

Advantageously, the group R comprising at least one quaternary amine group is represented by formula (III) in which:

X⁻ is chosen from organic anions, preferably conjugate bases of carboxylic acids,

R₂ is chosen from C₁ to C₃₄ hydrocarbon-based chains, preferably C₁ to C₁₈ alkyl groups,

R₃, R₄ and R₅ are identical or different and chosen independently from C₁ to C₁₈ hydrocarbon-based chains, optionally substituted with at least one hydroxyl group, it being understood that at least one of the groups R₃, R₄ and R₅ contains one or more hydroxyl groups.

According to a particular embodiment, the unit of formula (I) is obtained from an apolar monomer (mₐ).

Preferably, the apolar monomer (mₐ) corresponds to formula (VII) below:

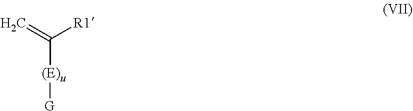

in which

R₁′, E, G and u are as defined above; the preferred variants of R₁′, E, G and u according to formula (I) as defined above are also preferred variants of formula (VII).

Advantageously, the group R₁′ is a hydrogen atom.

When the group E of the apolar monomer (mₐ) is an —O—CO— group, it being understood that the —O—CO— group is connected to the vinyl carbon via the oxygen atom, the monomer (mₐ) is preferably chosen from C₁ to C₃₄, preferably C₄ to C₃₀, more preferentially C₆ to C₂₄ and more preferentially C₈ to C₂₂ alkyl vinyl esters. The alkyl radical of the alkyl vinyl ester is linear or branched, cyclic or acyclic, preferably acyclic.

Among the alkyl vinyl esters, examples that may be mentioned include vinyl octanoate, vinyl decanoate, vinyl dodecanoate, vinyl tetradecanoate, vinyl hexadecanoate, vinyl octadecanoate, vinyl docosanoate and vinyl 2-ethylhexanoate.

When the group E of the apolar monomer (mₐ) is a —CO—O— group, it being understood that the —CO—O— group is connected to the vinyl carbon via the carbon atom, the monomer (mₐ) is preferably chosen from C₁ to C₃₄, preferably C₄ to C₃₀, more preferentially C₆ to C₂₄ and more preferentially C₈ to C₂₂ alkyl acrylates or methacrylates. The alkyl radical of the acrylate or methacrylate is linear or branched, cyclic or acyclic, preferably acyclic.

Among the alkyl (meth)acrylates that may be used, mention may be made, in a nonlimiting manner, of: n-octyl acrylate, n-octyl methacrylate, n-decyl acrylate, n-decyl methacrylate, n-dodecyl acrylate, n-dodecyl methacrylate, 2-ethylhexyl acrylate, 2-ethylhexyl methacrylate, isooctyl acrylate, isooctyl methacrylate, isodecyl acrylate, isodecyl methacrylate.

According to a first embodiment, the unit of formula (II) is obtained from polar monomers (m_{b}) chosen from those of formula (VIII):

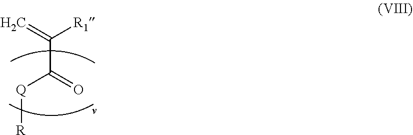

in which

R₁″, v, Q and R are as defined above; the preferred variants of R₁″, v, Q and R according to formula (II) as defined above are also preferred variants of formula (VIII),

it being understood that 5 mol % to 95 mol % of the polar monomers (m_{b}) comprise a group R containing at least one quaternary amine group.

According to a particular embodiment, 5 mol % to 95 mol % of the polar monomers (m_{b}) are represented by at least one of the formulae (IX) and (IX′) below:

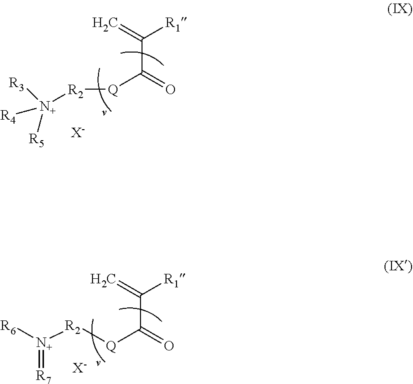

and 5 mol % to 95 mol % of the polar monomers (m_{b}) are represented by formula (X) below:

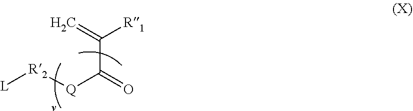

in which formulae (IX), (IX′) and (X):
R1″, v and Q are as defined above; the preferred variants of R1″ and Q according to formula (II) as defined above are also preferred variants of formulae (IX), (IX′) and (X);
X⁻, R₂, R₃, R₄, R₅, R₆ and R₇ are as defined above; the preferred variants X⁻, R₂, R₃, R₄, R₅, R₆ and R₇ according to formulae (III) and (IV) as defined above are also preferred variants of formulae (IX) and (IX′).
R′₂ and L are as defined above; the preferred variants of R′₂ and L according to formula (V) as defined above are also preferred variants of formula (X).

According to a second embodiment, the unit of formula (II) is obtained from a polar monomer (m_{b}) chosen from those of formula (VIII):

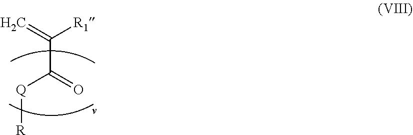

in which
R₁″, v and Q are as defined above; the preferred variants of R₁″ and Q according to formula (II) as defined above are also preferred variants of formula (VIII), and
R represents a C₁ to C₃₄ hydrocarbon-based chain which may also contain one or more nitrogen and/or oxygen atoms and/or carbonyl groups, substituted with at least one non-quaternary amine group.

In this second embodiment, the copolymerization of the monomer (m_{b}) is followed by partial quaternization of the quaternizable amine groups, for 5 mol % to 95 mol % of the units derived from said monomer (m_{b}).

This second embodiment is preferred.

According to a particular embodiment, the copolymer may be obtained by copolymerization of at least one apolar monomer (mₐ) and of at least one polar monomer (m_{b}) as described above.

According to a particular preferred embodiment, the copolymer is obtained only from apolar monomers (mₐ) and from polar monomers (m_{b}).

The copolymer may be prepared according to any known polymerization process. The various polymerization techniques and conditions are widely described in the literature and fall within the general knowledge of a person skilled in the art.

According to a particular embodiment, the copolymer is a block copolymer comprising at least one block A and at least one block B.

Block A corresponds to formula (XI) below:

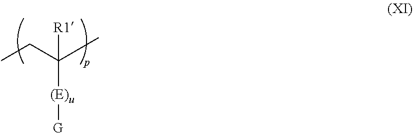

in which
p is an integer ranging from 2 to 100, preferably from 5 to 80, preferably from 10 to 70, more preferentially from 20 to 60.
R₁′, E, G and u are as defined above; the preferred variants of R₁′, E, G and u according to formula (I) as defined above are also preferred variants of formula (XI).

Block B corresponds to formula (XII) below:

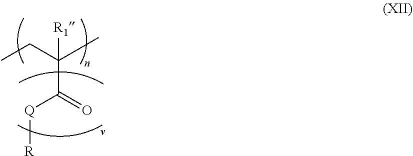

in which
v=0 or 1,
n is an integer ranging from 2 to 50, preferably from 3 to 40, more preferentially from 4 to 20, even more preferentially from 5 to 10,
R₁″, Q and R are as defined above; the preferred variants of R₁″, Q and R according to formula (II) as defined above are also preferred variants of formula (XII),
it being understood that 5 mol % to 95 mol % of the units of block B comprise a group R containing at least one quaternary amine group.

According to a particular embodiment, block B comprises:
from 5 mol % to 95 mol % of units corresponding to at least one of the formulae (XIII) and (XIII′) below:

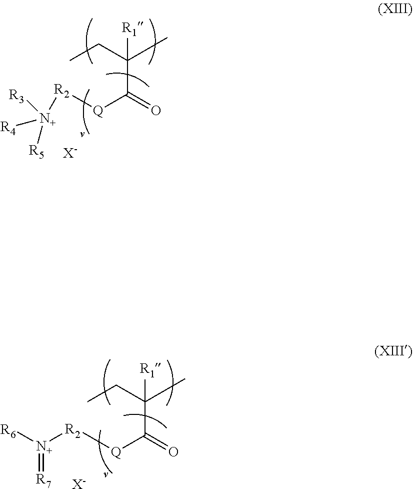

and from 5 mol % to 95 mol % of units corresponding to formula (XIV) below:

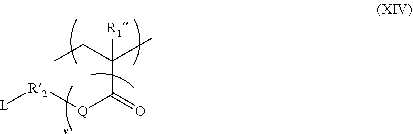

in which formulae (XIII), (XIII′) and (XIV)
Q, R₁″, n and v are as described above; the preferred variants of Q and R₁″ according to formula (II) as defined above are also preferred variants of formulae (XIII), (XIII′) and (XIV),
X⁻, R₂, R₃, R₄, R₅, R₆ and R₇ are as defined above; the preferred variants X⁻, R₂, R₃, R₄, R₅, R₆ and R₇ according to formulae (III) and (IV) as defined above are also preferred variants of formulae (XIII) and (XIII′).
R′₂ and L are as defined above; the preferred variants of R′₂ and L according to formula (V) are also preferred variants of formula (XIV).

The quaternary amine groups of the units of block B are advantageously chosen from trialkylammonium, iminium, amidinium, formamidinium, guanidinium and biguanidinium quaternary ammoniums, preferably trialkylammonium quaternary ammoniums.

The quaternary amine groups of the units of block B may also be chosen from heterocyclic compounds containing at least one nitrogen atom, chosen in particular from pyrrolinium, pyridinium, imidazolium, triazolium, triazinium, oxazolium and isoxazolium quaternary ammoniums.

The quaternary amine groups of the units of block B are advantageously quaternary trialkylammonium groups.

According to a preferred variant, at least one of the alkyl groups of the quaternary ammonium of block B is substituted with a hydroxyl group.

According to a particularly preferred embodiment, block B comprises from 5 mol % to 95 mol % of units corresponding to formula (XIII):

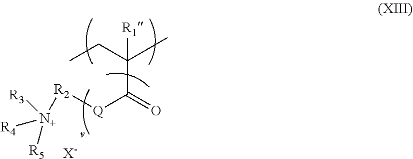

in which
v=0 or 1,
R₁″ is chosen from a hydrogen atom and a methyl group,
Q is chosen from an oxygen atom and a group —NR′— with R′ being chosen from a hydrogen atom and C₁ to C₁₂ hydrocarbon-based chains,
X⁻ is chosen from organic anions, preferably conjugate bases of carboxylic acids,
R₂ is chosen from C₁ to C₃₄ hydrocarbon-based chains, preferably C₁ to C₁₈ alkyl groups,
R₃, R₄ and R₅ are identical or different and chosen independently from C₁ to C₁₈ hydrocarbon-based chains, optionally substituted with at least one hydroxyl group, it being understood that at least one of the groups R₃, R₄ and R₅ contains at least one hydroxyl group.

The distribution within block B of the units whose group R comprises at least one quaternary ammonium function relative to the other units of block B may be of any type, and notably of random, statistical or block type. Preferably, this distribution is of random type.

According to a particular embodiment, block A consists of a chain of structural units derived from at least one monomer (mₐ) as described above.

According to a particular embodiment, block B consists of a chain of structural units derived from monomers (m_{b}) as described above.

According to a particular embodiment, block A consists of a chain of structural units derived from an alkyl acrylate or alkyl methacrylate monomer (mₐ) and block B corresponds to formula (XII) described above.

According to a particular embodiment, the block copolymer is obtained by copolymerization of at least the alkyl (meth)acrylate monomer (mₐ) and of at least the monomer(s) (m_{b}) described above.

It is understood that it would not constitute a departure from the invention if the copolymer (a) according to the invention were obtained from monomers other than (mₐ) and (m_{b}), provided that the final copolymer corresponds to that of the invention, i.e. a copolymer comprising units of formula (I) and units of formula (II) as described above. For example, it would not constitute a departure from the invention if the copolymer were obtained by copolymerization of monomers other than (mₐ) and (m_{b}) followed by a post-functionalization.

For example, the blocks derived from an apolar monomer (mₐ) may be obtained from vinyl alcohol or from acrylic acid, respectively, by transesterification or amidation reaction.

For example, the quaternary ammonium units of the block B may be obtained by post-functionalization of intermediate units (Mᵢ) derived from the polymerization of an intermediate (meth)acrylate or (meth)acrylamide monomer (mᵢ) of formulae:

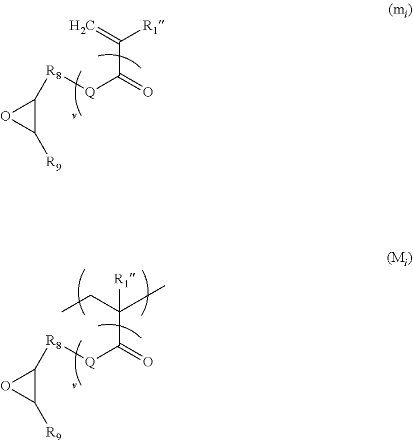

with
v, Q and R₁″ are as described above,
R₈ is chosen from C₁ to C₃₂ hydrocarbon-based chains,
R₉ is chosen from hydrogen and C₁ to C₆ alkyl groups,
said post-functionalization corresponding to the reaction of said intermediate unit (Mᵢ) with a tertiary amine NR₃R₄R₅ or R₆N═R₇ in which R₃, R₄, R₅, R₆ and R₇ are as defined above in formulae (III) and (IV).

The copolymer according to the invention may also be obtained by post-functionalization of an intermediate block polymer, comprising at least one intermediate block containing units (Mᵢ) and at least one block A as described above.

According to a particularly preferred embodiment, block B of formula (XII) is obtained by quaternization, according to any known process, of 5 mol % to 95 mol % of units of an intermediate block Bi comprising a single unit of formula (XII) in which the groups R contain a tertiary amine group of formula NR₃R₄R₅ or R₆N═R₇ in which R₃, R₄, R₅, R₆ and R₇ are as defined above.

The quaternization step may be performed before the copolymerization reaction, on an intermediate monomer bearing the tertiary amine, for example by reaction with an alkyl halide or an epoxide (oxirane) according to any known process, optionally followed by an anion exchange reaction.

The quaternization step may also be performed by post-functionalization of an intermediate polymer bearing the tertiary amine, for example by reaction with an alkyl halide optionally followed by an anion exchange reaction. An example of a quaternization that may be mentioned is a post-functionalization reaction of an intermediate polymer bearing the tertiary amine, by reaction with an epoxide (oxirane) according to any known process.

It is preferred to copolymerize intermediate monomers bearing a tertiary amine function and then, in a second step, to functionalize the intermediate copolymer obtained by quaternization of the tertiary amine present in the intermediate copolymer, rather than to copolymerize monomers that are already quaternized.

In addition, quaternization involving an epoxide will preferably be performed.

The block copolymer may be obtained by block polymerization, preferably by controlled block polymerization, optionally followed by one or more post-functionalizations.

According to a particular embodiment, the block copolymer described above is obtained by controlled block polymerization. The polymerization is advantageously chosen from controlled radical polymerization; for example atom transfer radical polymerization (ATRP); nitroxide-mediated radical polymerization (NMP); degenerative transfer processes such as degenerative iodine transfer polymerization (ITRP: iodine transfer radical polymerization) or reversible addition-fragmentation chain-transfer radical polymerization (RAFT: reversible addition-fragmentation chain transfer); polymerizations derived from ATRP such as polymerizations using initiators for continuous activator regeneration (ICAR) or using activators regenerated by electron transfer (ARGET).

Mention will be made, by way of example, of the publication “Macromolecular engineering by atom transfer radical polymerization”, JACS, 136, 6513-6533 (2014), which describes a controlled block polymerization process for forming block copolymers.

Mention may be made, for example, for NMP, of the identification by C. J. Hawker of an alkoxyamine that is capable of acting as a unimolecular agent, simultaneously providing the reactive initiator radical and the intermediate nitroxide radical in stable form (C. J. Hawker, J. Am. Chem. Soc., 1994, 116, 11185). Hawker also developed a universal NMP initiator (D. Benoit et al., J. Am. Chem. Soc., 1999, 121, 3904).

Reversible addition-fragmentation chain transfer (RAFT) radical polymerization is a living radical polymerization technique. The RAFT technique was discovered in 1988 par by the Australian scientific research organization CSIRO (J. Chiefari et al., Macromolecules, 1998, 31, 5559). The RAFT technique very rapidly became the subject of intensive research by the scientific community since it allows the synthesis of macromolecules having complex architectures, notably block, grafted or comb structures or else star-shaped structures, while at the same time making it possible to control the molecular mass of the macromolecules obtained (G. Moad et al., Aust. J. Chem, 2005, 58, 379). RAFT polymerization may be applied to a very wide range of vinyl monomers and under various experimental conditions, including its use for the preparation of water-soluble materials (C. L. McCormick et al., Acc. Chem. Res. 2004, 37, 312). The RAFT process includes the conventional radical polymerization of a substituted monomer in the presence of a suitable chain-transfer agent (CTA or RAFT agent). The RAFT agents commonly used comprise thiocarbonylthio compounds such as dithioesters (J. Chiefari et al., Macromolecules, 1998, 31, 5559), dithiocarbamates (R. T. A. Mayadunne et al., Macromolecules, 1999, 32, 6977; M. Destarac et al., Macromol. Rapid. Commun., 2000, 21, 1035), trithiocarbonates (R. T. A. Mayadunne et al., Macromolecules, 2000, 33, 243) and xanthates (R. Francis et al., Macromolecules, 2000, 33, 4699), which perform the polymerization via a reversible chain-transfer process. The use of a suitable RAFT agent allows the synthesis of polymers having a high degree of functionality and having a narrow molecular weight distribution, i.e. a low polydispersity index (PDI).

Examples of descriptions of RAFT radical polymerizations that may be mentioned include the following documents: WO 1998/01478, WO 1999/31144, WO 2001/77198, WO 2005/00319, WO 2005/000924.

The controlled block polymerization is typically performed in a solvent, under an inert atmosphere, at a reaction temperature generally ranging from 0 to 200° C., preferably from 50° C. to 130° C. The solvent may be chosen from polar solvents, in particular ethers such as anisole (methoxybenzene) or tetrahydrofuran, or apolar solvents, in particular paraffins, cycloparaffins, aromatics and alkylaromatics containing from 1 to 19 carbon atoms, for example benzene, toluene, cyclohexane, methylcyclohexane, n-butene, n-hexane, n-heptane and the like.

For atom transfer radical polymerization (ATRP), the reaction is generally performed under vacuum in the presence of an initiator, a ligand and a catalyst. Examples of ligands that may be mentioned include N,N,N′,N″,N″-pentamethyldiethylenetriamine (PMDETA), 1,1,4,7,10,10-hexamethyltriethylenetetramine (HMTETA), 2,2′-bipyridine (BPY) and tris(2-pyridylmethyl)amine (TPMA). Examples of catalysts that may be mentioned include: CuX, CuX₂, with X═Cl, Br and complexes based on ruthenium Ru²⁺/Ru³⁺.

ATRP polymerization is preferably performed in a solvent chosen from polar solvents.

According to the controlled block polymerization technique, it may also be envisaged to work under pressure.

The number of equivalents of apolar monomer (mₐ) of the block A and of polar monomer (m_{b}) of the block B reacted during the polymerization reaction may be identical or different.

The term “number of equivalents” means the amounts (in moles) of material of the monomers (mₐ) of block A and of the monomers (m_{b}) of block B used during the polymerization reaction.

The number of equivalents of apolar monomer (mₐ) of the block A is preferably from 2 to 100 eq, preferably from 5 to 80 eq, preferably from 10 to 70 eq and more preferentially from 20 to 60 eq.

The number of equivalents of polar monomers (m_{b}) of the block B is preferably from 2 to 50 eq, preferably from 3 to 40 eq, more preferentially from 4 to 20 eq and even more preferentially from 5 to 10 eq.

The number of equivalents of monomer (mₐ) of the block A is advantageously greater than or equal to that of the monomers (m_{b}) of the block B.

Preferably, when the group E of the apolar monomer (mₐ) is a —CO—O— group, E being connected to the vinyl carbon via the carbon atom, the number of equivalents of monomer (mₐ) of the block A is between 20 and 60 mol, and G is chosen from C₄ to C₃₀ hydrocarbon-based chains.

Even more preferentially, when the group E of the apolar monomer (mₐ) is a —CO— group, E being connected to the vinyl carbon via the carbon atom, the number of equivalents of monomer (mₐ) of the block A is between 20 and 60 mol, and G is chosen from C₄ to C₃₀ hydrocarbon-based chains, and the copolymer has a number-average molecular mass (Mn) ranging from 1000 to 10 000 g·mol⁻¹.

In addition, the weight-average molar mass M_{w} of the block A or of the block B is preferably less than or equal to 15 000 g·mol.⁻¹, more preferentially less than or equal to 10 000 g·mol.⁻¹.

The block copolymer advantageously comprises at least one sequence of blocks AB, ABA or BAB in which said blocks A and B form a sequence without the presence of an intermediate block of different chemical nature.

Other blocks may optionally be present in the block copolymer described previously provided that these blocks do not fundamentally change the nature of the block copolymer. However, block copolymers containing only blocks A and B will be preferred.

Advantageously, blocks A and B represent at least 70% by mass, preferably at least 90% by mass, more preferentially at least 95% by mass and even more preferentially at least 99% by mass of the block copolymer.

According to a particular embodiment, the block copolymer is a diblock copolymer.

According to another particular embodiment, the block copolymer is a triblock copolymer containing alternating blocks comprising two blocks A and one block B (ABA) or comprising two blocks B and one block A (BAB).

According to a particular embodiment, the block copolymer also comprises an end chain I consisting of a cyclic or acyclic, saturated or unsaturated, linear or branched C₁ to C₃₂, preferably C₄ to C₂₄ and more preferentially C₁₀ to C₂₄ hydrocarbon-based chain.

The term “cyclic hydrocarbon-based chain” means a hydrocarbon-based chain of which at least part is cyclic, notably aromatic. This definition does not exclude hydrocarbon-based chains comprising both an acyclic part and a cyclic part.

The end chain I may comprise an aromatic hydrocarbon-based chain, for example benzene-based, and/or a saturated and acyclic, linear or branched hydrocarbon-based chain, in particular an alkyl chain.

The end chain I is preferably chosen from alkyl chains, which are preferably linear, more preferentially alkyl chains of at least 4 carbon atoms and even more preferentially of at least 12 carbon atoms.

For the ATRP polymerization, the end chain I is located in the end position of the block copolymer. It may be introduced into the block copolymer by means of the polymerization initiator. Thus, the end chain I may advantageously constitute at least part of the polymerization initiator and is positioned within the polymerization initiator so as to make it possible to introduce, during the first step of polymerization initiation, the end chain I in the end position of the block copolymer.

The polymerization initiator is chosen, for example, from the free-radical initiators used in the ATRP polymerization process. These free-radical initiators well known to those skilled in the art are notably described in the article “Atom transfer radical polymerization: current status and future perspectives, Macromolecules, 45, 4015-4039, 2012”.

The polymerization initiator is chosen, for example, from alkyl esters of a carboxylic acid substituted with a halide, preferably a bromine in the alpha position, for example ethyl 2-bromopropionate, ethyl α-bromoisobutyrate, benzyl chloride or bromide, ethyl α-bromophenylacetate and chloroethylbenzene. Thus, for example, ethyl 2-bromopropionate may make it possible to introduce into the copolymer the end chain I in the form of a C₂ alkyl chain and benzyl bromide in the form of a benzyl group.

For the RAFT polymerization, the transfer agent may conventionally be removed from the copolymer at the end of polymerization according to any known process.

According to one variant, the end chain I may also be obtained in the copolymer by RAFT polymerization according to the methods described in the article by Moad, G. et al., Australian Journal of Chemistry, 2012, 65, 985-1076. For example, the end chain I may be modified by aminolysis when a transfer agent is used to give a thiol function. Examples that may be mentioned include transfer agents of thiocarbonylthio, dithiocarbonate, xanthate, dithiocarbamate and trithiocarbonate type, for example S,S₀-dibenzyl trithiocarbonate (DBTTC), S,S-bis(α,α′-dimethyl-α″-acetic acid) trithiocarbonate (BDMAT) or 2-cyano-2-propyl benzodithioate (CPD).

According to a known process, the transfer agent may be cleaved at the end of polymerization by reacting a cleaving agent such as C₂-C₆ alkylamines; the end function of the copolymer may in this case be a thiol group —SH.

According to another process described in patent EP 1 751 194, the sulfur of the copolymer obtained by RAFT polymerization introduced by the sulfur-based transfer agent such as thiocarbonylthio, dithiocarbonate, xanthate, dithiocarbamate and trithiocarbonate may be converted so as to remove the sulfur from the copolymer.

According to a particular embodiment, the block copolymer is a diblock copolymer. The block copolymer structure may be of the IAB or IBA type, advantageously IAB. The end chain I may be directly linked to block A or B according to the structure IAB or IBA, respectively, or may be connected via a bonding group, for example an ester, amide, amine or ether function. The bonding group then forms a bridge between the end chain I and block A or B.

According to a particular embodiment, the block copolymer may also be functionalized at the chain end according to any known process, notably by hydrolysis, aminolysis and/or nucleophilic substitution.

The term “aminolysis” means any chemical reaction in which a molecule is split into two parts by reaction of an ammonia or amine molecule. A general example of aminolysis consists in replacing a halogen of an alkyl group by reaction with an amine, with removal of hydrogen halide. Aminolysis may be used, for example, for an ATRP polymerization which produces a copolymer bearing a halide in the end position or for a RAFT polymerization to convert the thio, dithio or trithio bond introduced into the copolymer by the RAFT transfer agent into a thiol function.

An end chain I′ may thus be introduced by post-functionalization of the block copolymer obtained by controlled block polymerization of the monomers mₐ and m_{b} described above.

The end chain I′ advantageously comprises a linear or branched, cyclic or acyclic C₁ to C₃₂, preferably C₁ to C₂₄ and more preferentially C₁ to C₁₀ hydrocarbon-based chain, even more preferentially an alkyl group, optionally substituted with one or more groups containing at least one heteroatom chosen from N and O, preferably N.

For an ATRP polymerization using a metal halide as catalyst, this functionalization may be performed, for example, by treating the copolymer IAB or IBA obtained by ATRP with a primary C₁ to C₃₂ alkylamine or a C₁ to C₃₂ alcohol under mild conditions so as not to modify the functions present on blocks A, B and I.

Uses

The copolymers described above are most particularly useful as additive for liquid fuels for internal combustion engines.

The use of such copolymers is particularly advantageous as detergent additive in a liquid fuel for an internal combustion engine.

The term “detergent additive for liquid fuel” means an additive which is incorporated in small amount into the liquid fuel and produces an effect on the cleanliness of said engine when compared with said liquid fuel not specially supplemented.

The use of such copolymers is also particularly advantageous as demulsifying additive in a liquid fuel for an internal combustion engine.

The term “demulsifying additive” means an additive which is incorporated in small amount into the liquid fuel and which makes it possible to improve the separation of the water and the fuel when said fuel contains water.

In particular, the use of the copolymers according to the invention in a liquid fuel makes it possible simultaneously to maintain the cleanliness of at least one of the internal parts of the internal combustion engine and/or to clean at least one of the internal parts of the internal combustion engine and also makes it possible to improve the separation of the water and the fuel when the latter contains water.

The term “improve the separation of the water and the fuel” means accelerating the separation, and/or increasing the degree of separation, of the fuel and of the residual water present in this fuel, when compared with a fuel that is free of said additive composition.

The liquid fuel is advantageously derived from one or more sources chosen from the group consisting of mineral, animal, plant and synthetic sources. Oil will preferably be chosen as mineral source.

The liquid fuel is preferably chosen from hydrocarbon-based fuels and fuels that are not essentially hydrocarbon-based, alone or as a mixture.

The term “hydrocarbon-based fuel” means a fuel constituted of one or more compounds constituted solely of carbon and hydrogen.

The term “fuel that is not essentially hydrocarbon-based” means a fuel constituted of one or more compounds not essentially constituted of carbon and hydrogen, i.e. which also contain other atoms, in particular oxygen atoms.

The hydrocarbon-based fuels notably comprise middle distillates with a boiling point ranging from 100 to 500° C. or lighter distillates with a boiling point in the gasoline range. These distillates may be chosen, for example, from the distillates obtained by direct distillation of crude hydrocarbons, vacuum distillates, hydrotreated distillates, distillates derived from the catalytic cracking and/or hydrocracking of vacuum distillates, distillates resulting from conversion processes such as ARDS (atmospheric residue desulfurization) and/or viscoreduction, and distillates derived from the upgrading of Fischer-Tropsch fractions. The hydrocarbon-based fuels are typically gasolines and gas oils (also known as diesel fuel).

Advantageously, the hydrocarbon-based fuel is chosen from gasolines and gas oils.

Gasolines in particular comprise any commercially available fuel composition for spark ignition engines. A representative example that may be mentioned is the gasolines corresponding to the standard NF EN 228. Gasolines generally have octane numbers that are high enough to avoid pinking. Typically, the fuels of gasoline type sold in Europe, in accordance with the standard NF EN 228, have a motor octane number (MON) of greater than 85 and a research octane number (RON) of at least 95. Fuels of gasoline type generally have an RON ranging from 90 to 100 and an MON ranging from 80 to 90, the RON and MON being measured according to the standard ASTM D 2699-86 or D 2700-86.

Gas oils (diesel fuels) in particular comprise any commercially available fuel composition for diesel engines. A representative example that may be mentioned is the gas oils corresponding to the standard NF EN 590.

Fuels that are not essentially hydrocarbon-based notably comprise oxygen-based compounds, for example distillates resulting from the BTL (biomass to liquid) conversion of plant and/or animal biomass, taken alone or in combination; biofuels, for example plant and/or animal oils and/or plant and/or animal oil esters; biodiesels of animal and/or plant origin and bioethanols.

The mixtures of hydrocarbon-based fuel and of fuel that is not essentially hydrocarbon-based are typically gas oils of Bₓ type or gasolines of Ex type.

The term “gas oil of Bₓ type for diesel engines” means a gas oil fuel which contains x % (v/v) of plant or animal oil esters (including spent cooking oils) transformed via a chemical process known as transesterification, obtained by reacting this oil with an alcohol so as to obtain fatty acid esters (FAE). With methanol and ethanol, fatty acid methyl esters (FAME) and fatty acid ethyl esters (FAEE) are obtained, respectively. The letter “B” followed by a number indicates the percentage of FAE contained in the gas oil. Thus, a B99 contains 99% of FAE and 1% of middle distillates of fossil origin (mineral source), B20 contains 20% of FAE and 80% of middle distillates of fossil origin, etc. A distinction is thus made between gas oils of the Bo type which do not contain any oxygen-based compounds, and gas oils of the Bₓ type which contain x % (v/v) of esters of plant oils or of fatty acids, usually methyl esters (POME or FAME). When the FAE is used alone in engines, the fuel is designated by the term B100.

The term “gasoline of Ex type for spark ignition engines” means a gasoline fuel which contains x % (v/v) of oxygen-based compounds, generally ethanol, bioethanol and/or tert-butyl ethyl ether (TBEE).

The sulfur content of the liquid fuel is preferably less than or equal to 5000 ppm, preferably less than or equal to 500 ppm and more preferentially less than or equal to 50 ppm, or even less than 10 ppm and advantageously sulfur-free.

According to a particular embodiment, the use of the copolymer(s) according to the invention in the liquid fuel makes it possible to maintain the cleanliness of at least one of the internal parts of the internal combustion engine and/or to clean at least one of the internal parts of the internal combustion engine.

The use of said copolymer in the liquid fuel makes it possible in particular to limit or prevent the formation of deposits in at least one of the internal parts of said engine (“keep-clean” effect) and/or to reduce the existing deposits in at least one of the internal parts of said engine (“clean-up” effect).

Thus, the use of said copolymer in the liquid fuel makes it possible, when compared with liquid fuel that is not specially supplemented, to limit or prevent the formation of deposits in at least one of the internal parts of said engine or to reduce the existing deposits in at least one of the internal parts of said engine.

Advantageously, the use of said copolymer as additive in the liquid fuel makes it possible to observe both effects simultaneously, limitation (or prevention) and reduction of deposits (“keep-clean” and “clean-up” effects).

The deposits are distinguished as a function of the type of internal combustion engine and of the location of the deposits in the internal parts of said engine.

According to a particular embodiment, the internal combustion engine is a spark ignition engine, preferably with direct injection (DISI: direct-injection spark ignition engine). The deposits targeted are located in at least one of the internal parts of said spark ignition engine. The internal part of the spark ignition engine that is kept clean (keep-clean) and/or cleaned (clean-up) is advantageously chosen from the engine intake system, in particular the intake valves (IVD: intake valve deposit), the combustion chamber (CCD: combustion chamber deposit, or TCD: total chamber deposit) and the fuel injection system, in particular the injectors of an indirect injection system (PFI: port fuel injector) or the injectors of a direct injection system (DISI).

According to another particular embodiment, the internal combustion engine is a diesel engine, preferably a direct-injection diesel engine, in particular a diesel engine with a common-rail injection system (CRDI: common-rail direct injection). The deposits targeted are located in at least one of the internal parts of said diesel engine.

Advantageously, the deposits targeted are located in the injection system of the diesel engine, preferably located on an external part of an injector of said injection system, for example the injector tip, and/or on an internal part of an injector of said injection system (IDID: internal diesel injector deposits), for example on the surface of an injector needle.

The deposits may be constituted of coking-related deposits and/or deposits of soap and/or lacquering type.

The copolymer(s) as described previously may advantageously be used as additives in the liquid fuel to reduce and/or prevent power loss due to the formation of deposits in the internal parts of a direct-injection diesel engine, said power loss being determined according to the standardized engine test method CEC F-98-08.

Said copolymer may advantageously be used in the liquid fuel to reduce and/or prevent restriction of the fuel flow emitted by the injector of a direct-injection diesel engine during its functioning, said flow restriction being determined according to the standardized engine test method CEC F-23-1-01.

Advantageously, the use of said copolymer as a fuel additive makes it possible, when compared with liquid fuel that is not specially supplemented, to limit or prevent the formation of deposits on at least one type of deposit described previously and/or to reduce the existing deposits on at least one type of deposit described previously.

According to a particular embodiment, the use of said copolymer as a fuel additive also makes it possible to reduce the fuel consumption of an internal combustion engine.

According to another particular embodiment, the use of said copolymer as a fuel additive also makes it possible to reduce the pollutant emissions, in particular the particle emissions of an internal combustion engine.

Advantageously, the use of said copolymer as a fuel additive makes it possible to reduce both the fuel consumption and the pollutant emissions.

The copolymer(s) as described above may be used alone or mixed with other additives in the form of an additive concentrate.

The copolymers according to the invention may be added to the liquid fuel in a refinery and/or may be incorporated downstream of the refinery and/or optionally as a mixture with other additives in the form of an additive concentrate, also known by the common name “additive package”.

According to one embodiment, the copolymer according to the invention is used as a mixture with an organic liquid in the form of a concentrate.

According to a particular embodiment, a concentrate for fuel comprises one or more copolymers as described above, as a mixture with an organic liquid.

The organic liquid is inert with respect to the copolymer(s) according to the invention and miscible in the liquid fuel described previously. The term “miscible” describes the fact that the copolymer and the organic liquid form a solution or a dispersion so as to facilitate the mixing of the copolymer according to the invention in the liquid fuels according to the standard fuel supplementation processes.

The organic liquid is advantageously chosen from aromatic hydrocarbon-based solvents such as the solvent sold under the name Solvesso, alcohols, ethers and other oxygen-based compounds and paraffinic solvents such as hexane, pentane or isoparaffins, alone or as a mixture.

The concentrate may advantageously comprise a total amount of copolymer(s) according to the invention ranging from 5% to 99% by weight, preferably from 10% to 80% by weight and more preferentially from 25% to 70% by weight.

The concentrate may typically comprise from 1% to 95% by weight, preferably from 20% to 90% by weight and more preferentially from 30% to 75% by weight of organic liquid, the remainder corresponding to the copolymer according to the invention, it being understood that the concentrate may comprise one or more copolymers as described above.

In general, when the copolymer according to the invention is a block copolymer, its solubility in the organic liquids and the liquid fuels described previously notably depends on the weight-average and number-average molar masses M_{w} and Mₙ, respectively, of the copolymer. The average molar masses M_{w} and Mₙ of the copolymer according to the invention will be chosen so that the copolymer is soluble in the liquid fuel and/or the organic liquid of the concentrate for which it is intended.

The average molar masses M_{w} and Mₙ of the copolymer according to the invention may also have an influence on the efficiency of said copolymer as a detergent additive in fuels. The average molar masses M_{w} and Mₙ will thus be chosen so as to optimize the effect of the copolymer according to the invention, notably the detergency effect (engine cleanliness) in the liquid fuels described above.

Optimizing the average molar masses M_{w} and Mₙ may be performed via routine tests accessible to those skilled in the art.

According to a particular embodiment, the copolymer according to the invention advantageously has a weight-average molar mass (M_{w}) ranging from 500 to 30 000 g·mol⁻¹, preferably from 1000 to 10 000 g·mol⁻¹, more preferentially less than or equal to 4000 g·mol⁻¹, and/or a number-average molar mass (Mn) ranging from 500 to 15 000 g·mol⁻¹, preferably from 1000 to 10 000 g·mol⁻¹, more preferentially less than or equal to 4000 g·mol⁻¹. The number-average and weight-average molar masses are measured by size exclusion chromatography (SEC). The operating conditions of SEC, notably the choice of the solvent, will be chosen as a function of the chemical functions present in the block copolymer.

The mole ratio and/or mass ratio between the polar monomer (m_{b}) and the apolar monomer (mₐ) and/or between block A and B in the block copolymer described above will also be chosen so that the block copolymer is soluble in the fuel and/or the organic liquid of the concentrate for which it is intended. Similarly, this ratio may be optimized as a function of the fuel and/or of the organic liquid so as to obtain the best effect on the engine cleanliness.

Optimizing the mole ratio and/or mass ratio may be performed via routine tests accessible to those skilled in the art.

According to a particular embodiment, the mole ratio between the apolar monomer (mₐ) and the polar monomer (m_{b}), or between blocks A and B as a molar percentage between the apolar monomer (mₐ) of block A and the polar monomer (m_{b}) of block B, is preferably between 95:5 and 50:50, more preferentially between 90:10 and 75:25, even more preferentially between 85:15 and 70:30.

According to a particular embodiment, the copolymer according to the invention is used in the form of an additive concentrate in combination with at least one other fuel additive for an internal combustion engine other than the copolymers according to the invention described previously.

The additive concentrate may typically comprise one or more other additives chosen from detergent additives other than the copolymers according to the invention, for example from anticorrosion agents, dispersants, demulsifiers, antifoams, biocides, reodorants, cetane boosters, friction modifiers, lubricity additives or oiliness additives, combustion aids (catalytic soot and combustion promoters), agents for improving the cloud point, the flow point or the FLT (filterability limit temperature), sedimentation-inhibiting agents, antiwear agents and conductivity modifiers.

Among these additives, mention may be made in particular of:
a) cetane boosters, notably (but not limitingly) chosen from alkyl nitrates, preferably 2-ethylhexyl nitrate, aryl peroxides, preferably benzyl peroxide, and alkyl peroxides, preferably tert-butyl peroxide;
b) antifoam additives, notably (but not limitingly) chosen from polysiloxanes, oxyalkylated polysiloxanes and fatty acid amides derived from plant or animal oils. Examples of such additives are given in EP861882, EP663000 and EP736590;
c) cold flow improvers (CFI) chosen from copolymers of ethylene and of an unsaturated ester, such as ethylene/vinyl acetate (EVA), ethylene/vinyl propionate (EVP), ethylene/vinyl ethanoate (EVE), ethylene/methyl methacrylate (EMMA) and ethylene/alkyl fumarate copolymers described, for example, in U.S. Pat. Nos. 3,048,479, 3,627,838, 3,790,359, 3,961,961 and EP261957;
d) lubricity additives or antiwear agents, notably (but not limitingly) chosen from the group consisting of fatty acids and ester or amide derivatives thereof, notably glyceryl monooleate, and monocyclic and polycyclic carboxylic acid derivatives. Examples of such additives are given in the following documents: EP680506, EP860494, WO98/04656, EP915944, FR2772783, FR2772784;
e) cloud point additives, notably (but not limitingly) chosen from the group consisting of long-chain olefin/(meth)acrylic ester/maleimide terpolymers, and fumaric/maleic acid ester polymers. Examples of such additives are given in FR2528051, FR2528051, FR2528423, EP112195, EP172758, EP271385 and EP291367;
f) detergent additives, notably (but not limitingly) chosen from the group consisting of succinimides, polyetheramines and quaternary ammonium salts; for example those described in U.S. Pat. No. 4,171,959 and WO2006135881;
g) cold workability polyfunctional additives chosen from the group consisting of polymers based on olefin and alkenyl nitrate as described in EP573490.

These other additives are generally added in an amount ranging from 10 to 1000 ppm (each), preferably from 100 to 1000 ppm by weight in the fuel composition.

According to a particular embodiment, a fuel composition is prepared according to any known process by supplementing the liquid fuel described previously with at least one copolymer as described above.

The invention also relates to a fuel composition comprising:

(1) a fuel as described above, and

(2) one or more copolymers as described previously.

The fuel (1) is chosen in particular from hydrocarbon-based fuels and fuels that are not essentially hydrocarbon-based described previously, taken alone or as a mixture.

The combustion of this fuel composition comprising the copolymer according to the invention in an internal combustion engine has an effect both on the cleanliness of the engine and on demulsifying when the fuel contains water, when compared with liquid fuel that is not specially supplemented. The combustion of this fuel composition makes it possible in particular to prevent and/or reduce the fouling of the internal parts of said engine while at the same time maintaining or even improving the demulsifying of said fuel. These effects on engine cleanliness and on demulsifying are as described previously in the context of the use of the copolymers according to the invention as fuel additives.

According to a particular embodiment, the combustion of the fuel composition comprising the copolymer according to the invention in an internal combustion engine also makes it possible to reduce the fuel consumption and/or the pollutant emissions.

The copolymer according to the invention is preferably incorporated in low amount into the liquid fuel described previously, the amount of copolymer being sufficient firstly to produce a detergent effect while at the same time maintaining or even improving the demulsifying, and thus improving the engine cleanliness.

The fuel composition advantageously comprises the copolymer(s) according to the invention in a total content of at least 5 ppm by weight, preferably at least 10 ppm, more preferentially in a content of from 10 to 5000 ppm, even more preferentially from 20 to 2000 ppm and better still from 50 to 1000 ppm.

Besides the copolymers according to the invention described above, the fuel composition may also comprise one or more other additives different from said copolymers. These additives are notably chosen from the other known detergent additives, for example from anticorrosion agents, dispersants, demulsifiers, antifoams, biocides, reodorants, cetane boosters, friction modifiers, lubricity additives or oiliness additives, combustion aids (catalytic soot and combustion promoters), agents for improving the cloud point, the flow point or the FLT, sedimentation-inhibiting agents, antiwear agents and/or conductivity modifiers.

The additives other than the copolymers according to the invention are, for example, the fuel additives listed above.

According to a particular embodiment, a process for maintaining the cleanliness of (keep-clean) and/or for cleaning (clean-up) at least one of the internal parts of an internal combustion engine comprises the preparation of a fuel composition by supplementation of a fuel with at least one copolymer as described above and the combustion of said fuel composition in the internal combustion engine.

According to a particular embodiment, the internal combustion engine is a spark ignition engine, preferably a direct-injection spark ignition (DISI) engine.

The internal part of the spark ignition engine that is kept clean and/or cleaned is preferably chosen from the engine intake system, in particular the intake valves (TVD), the combustion chamber (CCD or TCD) and the fuel injection system, in particular the injectors of an indirect injection system (PFI) or the injectors of a direct injection system (DISI).

According to another particular embodiment, the internal combustion engine is a diesel engine, preferably a direct-injection diesel engine, in particular a diesel engine with common-rail injection systems (CRDI).

The internal part of the diesel engine that is kept clean (keep-clean) and/or cleaned (clean-up) is preferably the injection system of the diesel engine, preferably an external part of an injector of said injection system, for example the injector tip, and/or one of the internal parts of an injector of said injection system, for example the surface of an injector needle.

The process for maintaining the cleanliness (keep-clean) and/or for cleaning (clean-up) preferably comprises the successive steps of:
1) determining the most suitable supplementation for the fuel, said supplementation corresponding to the selection of the copolymer(s) described above to be incorporated in combination, optionally, with other fuel additives as described previously and determining the rate of treatment necessary to achieve a given specification relative to the detergency of the fuel composition;
2) incorporating into the fuel the selected copolymer(s) at the rate determined in step 1) and, optionally, the other fuel additives.

Alternatively, the copolymer according to the invention and the other additives, where appropriate, may be used in the form of a concentrate or of an additive concentrate as described above.

Step 1) is performed according to any known process and is a matter of common practice in the field of fuel supplementation. This step involves defining at least one representative feature of the detergency properties of the fuel composition.

The representative feature of the detergency properties of the fuel will depend on the type of internal combustion engine, for example a diesel or spark ignition engine, the direct or indirect injection system and the location in the engine of the deposits targeted for cleaning and/or cleanliness maintenance.

For direct-injection diesel engines, the representative feature of the detergency properties of the fuel may correspond, for example, to the power loss due to the formation of deposits in the injectors or restriction of the fuel flow emitted by the injector during the functioning of said engine.

The representative feature of the detergency properties may also correspond to the appearance of lacquering-type deposits on the injector needle (IDID).

Methods for evaluating the detergent properties of fuels have been widely described in the literature and fall within the general knowledge of a person skilled in the art. Nonlimiting examples that will be mentioned include the tests standardized or acknowledged by the profession or the following methods described in the literature:

For direct-injection diesel engines:
the method DW10, standardized engine test method CEC F-98-08, for measuring the power loss of direct-injection diesel engines
the method XUD9, standardized engine test method CEC F-23-1-01 Issue 5, for measuring the restriction of fuel flow emitted by the injector
the method described by the Applicant in patent application WO 2014/029770, pages 17 to 20, for the evaluation of lacquering deposits (IDID), this method being cited by way of example and/or incorporated by reference into the present patent application.

For indirect-injection spark ignition engines:
the Mercedes Benz M102E method, standardized test method CEC F-05-A-93, and
the Mercedes Benz M111 method, standardized test method CEC F-20-A-98.

These methods make it possible to measure the intake valve deposits (IVD), the tests generally being performed on a Eurosuper gasoline corresponding to the standard EN228.

For direct-injection spark ignition engines:
the method described by the Applicant in the article “Evaluating Injector Fouling in Direct Injection Spark Ignition Engines”, Mathieu Arondel, Philippe China, Julien Gueit; Conventional and future energy for automobiles; 10th international colloquium; Jan. 20-22, 2015, pages 375-386 (Technische Akademie Esslingen par Techn. Akad. Esslingen, Ostfildern), for the evaluation of the injector coking deposits, this method being cited by way of example and/or incorporated by reference into the present patent application.
the method described in US 2013/0104826 for the evaluation of the injector coking deposits, this method being cited by way of example and/or incorporated by reference into the present patent application.

The process for demulsifying fuel or for separating water from fuel preferably comprises the successive steps of:
1′) determining the most suitable supplementation for the fuel, said supplementation corresponding to the selection of the copolymer(s) described above to be incorporated in combination, optionally, with other fuel additives as described previously and determining the rate of treatment necessary to achieve a given specification relative to the demulsifying of the fuel composition;
2′) incorporating into the fuel the selected copolymer(s) at the rate determined in step 1′) and, optionally, the other fuel additives;
3′) separating the water and the fuel.

Step 1′) is performed according to any known process and is a matter of common practice in the field of fuel supplementation. This step involves defining at least one representative feature of the demulsifying properties of the fuel composition.

The representative feature of the demulsifying properties may correspond, for example, to measurement of the volume of aqueous phase extracted from the fuel according to the standard ASTM D 1094.

Step 3′) is also performed according to any process known to those skilled in the art. For example, step 3′) may be performed by decantation of the supplemented fuel composition, followed by separating out the water.

The amount of copolymer(s) according to the invention to be added to the fuel composition to achieve a given specification will typically be determined by comparison with the fuel composition but without the copolymer(s) according to the invention.

The amount of copolymer(s) according to the invention to be added to the fuel composition to achieve the specification (step 1) or step 1′) described previously) will typically be determined by comparison with the fuel composition but without the copolymer(s) according to the invention, the specification given relative to the detergency possibly being, for example, a target power loss value according to the method DW10 or a flow restriction value according to the method XUD9 mentioned above.

The amount of copolymer(s) according to the invention may also vary as a function of the nature and origin of the fuel, for example as a function of the content of compounds bearing n-alkyl, isoalkyl or n-alkenyl substituents, or as a function of its water content. Thus, the nature and origin of the fuel may also be a factor to be taken into consideration for step 1) or 1′).

The process for maintaining the cleanliness (keep-clean) and/or for cleaning (clean-up) may also comprise an additional step 3) after step 2), of checking the target reached and/or of adjusting the rate of supplementation with the copolymer(s) according to the invention as detergent additive.

The copolymers according to the invention have noteworthy properties as detergent additive in a liquid fuel, in particular in a gas oil or gasoline fuel, without deteriorating the demulsifying of the water of said fuel when the latter contains water.

The copolymers according to the invention are particularly noteworthy notably because they are effective as detergent additive and as demulsifying additive for a wide range of liquid fuels and/or for one or more types of motorization and/or against several types of deposit that form in the internal parts of internal combustion engines.

### EXAMPLE

A copolymer in accordance with the present invention was synthesized in accordance with the protocol described below.

First Step:

Synthesis of an EHMA/DMAEMA diblock copolymer by RAFT radical polymerization:

EHMA Block A:

30.01 g (0.26 mol) of 2-ethylhexyl methacrylate (EHMA), 2.89 g (13 mmol) of 2-cyano-2-propyl benzodithioate and 35 mL of toluene are introduced into a 250 mL round-bottomed flask. 210 mg (1.29 mmol) of azobisisobutyronitrile (AIBN) are weighed out in a 20 mL round-bottomed flask and then dissolved in 4 mL of toluene. The two solutions are degassed with nitrogen for 30 minutes. The solution containing the EHMA monomer is heated to 80° C. When the temperature is reached, the AIBN solution is added using a syringe purged beforehand with nitrogen. The reaction medium is stirred for 24 hours at 80° C. under an inert atmosphere (N₂).

A 250 μL sample is collected at t0 (just after addition of AIBN) and at tf (final t) to measure the content of residual monomers by HPLC and thus to determine the conversion thereof.

Result: the area ratio of the peaks for the EHMA monomer gives a conversion of 98% (98% of the EHMA monomer was converted into polymer).

HPLC method: used: Utitmate 300 HPLC from Thermo Fischer. The stationary phase of the machine is a Symmetry Shield RP 18 column. The mobile phase is composed of two eluents, a first whose composition is water/methanol with CH2O2 at pH 5, and the second is composed of methanol with methanoic acid also at pH 5. This mobile phase has a flow rate of 1 mL/min. The oven temperature is set at 40° C. The injection volume is 5 μL. The products are detected via a diode array detector.

DMAEMA Block B:

10.22 g (88.7 mmol) of 2-(dimethylamino)ethyl methacrylate (DMAEMA) are weighed out in a 50 mL round-bottomed flask. 11 mL of toluene are added. Separately, 221 mg (1.35 mmol) of AIBN are weighed out in a 20 mL round-bottomed flask and then dissolved in 3 mL of toluene. After 30 minutes of degassing the two solutions with nitrogen, the DMAEMA monomer is added via a syringe, purged beforehand with nitrogen, to the flask containing the EHMA block A heated to 80° C., and the AIBN solution is then added. The reaction medium is stirred for 24 hours under an inert atmosphere (N₂).

A 250 μL sample is collected at t0 (just after addition of AIBN) and at tf (final t) to measure the content of residual monomers by HPLC (as described for block A above) and thus to determine the conversion thereof.

A sample is also collected to determine by ¹H and ¹³C NMR the number of EHMA and DMAEMA units and the mole ratio of the two monomers.

Analysis Method:

The ¹H and ¹³C NMR spectroscopy analyses were performed in deuterated chloroform CDCl₃ with a Bruker Avance III 400 MHz spectrometer (¹H Larmor frequency) operating under TopSpin 3.2: SEX 10 mm ¹³C probe with pulsed magnetic field z-gradient and ²H lock operating at 300 K and BBI 5 mm ¹H probe with pulsed magnetic field z-gradient and ²H lock operating at 300 K. To perform the measurements, an external standard (1,2,4,5-tetrachloro-3-nitrobenzene) is used.

Finally, the number-average molar masses Mn and mass-average molar masses Mw, and also the dispersity index, which reflects the size dispersity PI (PI=Mw/Mn), were determined by GPC.

The GPC analyses were performed in THF. In a typical analysis, 100 μL of sample at 0.5% m/m, prefiltered through a 0.45 μm Millipore filter, are injected into Waters Styragel columns operating at 40° C. and 645 psi with a flow rate of THF of 1 ml/min. The number-average molar masses (Mₙ) were determined by RI (refractive index) detection from calibration curves constructed for PMMA standards. The analyses were performed in a Waters Styragel column with the refractive index as detector.

Results
Conversion by HPLC: the area ratio of the peaks for the DMAEMA monomer gives a conversion of 97% (97% of the DMAEMA monomer was converted into polymer);
Microstructure by 1H and 13C NMR: on the basis of the signals relating to the chain ends, 17 EHMA units and 6 DMAEMA units are determined. The relative molar composition: 71% EHMA, 29% DMAEMA.
For the calculation of the number of units, by 13C NMR, setting the integral of the signal at 132.3 ppm (linked to 1 aromatic CH group of the benzodithioate) to 1, an integral for the unresolved peak for the OCH2 groups (1C) of the EHMA units (67.8-66.5 ppm) and an integral for the unresolved peak for the NCH2 groups (1C) of the DMAEMA units (57.4-56.8 ppm), respectively, of 17 and 6 are obtained. Thus, if it is assumed that all the polymer chains include the benzodithioate group as end group, then the copolymer includes 17 EHMA units and 6 DMAEMA units.
GPC: Mn=2800 g/mol, Mw=3400 g/mol, PI=1.28

Second Step:

Partial quaternization of block B of the EHMA/DMAEMA diblock copolymer:

28.5 g of the solution of diblock polymer in toluene prepared previously are taken up and placed in a 100 mL round-bottomed flask. 10.5 g of butanol, 912 mg (12.6 mmol) of epoxybutane and 735 mg (12.2 mmol) of acetic acid are added. The mixture is heated at 60° C. for 24 hours, with a Vigreux column on the flask. At the end of the reaction, the mixture is evaporated under reduced pressure.

After drying, a sample of the polymer is analyzed by ¹H and ¹³C NMR.

Results

The degree of quaternization of block B (DMAEMA block) is 40 mol %.

The degree of quaternization is determined by 13C NMR. In 13C NMR, the unresolved peak at about 70 ppm is assigned to the CH2 of the CH2CHOHCH2CH3 group alpha to the quaternized nitrogen atom. On the basis of the EHMA/DMAEMA molar proportion (71/29), and by comparing the integral of the unresolved peak at 70 ppm and the integral of the signal at 11 ppm (linked to one of the two CH3 groups of the EHMA side chain), the degree of quaternization is deduced, which is 40%.

Detergency Test:

The performance qualities in terms of detergency were evaluated using the XUD9 engine test, which consists in determining the loss of flow rate defined as corresponding to the restriction of the flow of a gas oil emitted by the injector of a prechamber diesel engine during its functioning, according to the standardized engine test method CEC F-23-1-01. The object of this XUD9 test is to evaluate the ability of the additive tested to maintain the cleanliness, “keep-clean” effect, of the injectors of a four-cylinder Peugeot XUD9 A/L prechamber injection diesel engine, in particular to evaluate its ability to limit the formation of deposits on the injectors.

The test was performed on a virgin gas oil of BO type corresponding to the standard EN590, supplemented with the polymer obtained on conclusion of the second step above, to a rate of treatment of 50 ppm by weight (50 mg/kg).

The test is started with a four-cylinder Peugeot XUD9 A/L prechamber injection diesel engine equipped with clean injectors, the flow rate of which was determined beforehand. The engine follows a given test cycle for 10 hours and 3 minutes (repetition of the same cycle 134 times). At the end of the test, the flow rate of the injectors is again evaluated. The amount of fuel required for the test is 60 L. The loss of flow rate is measured on the four injectors. The results are expressed as a percentage loss of flow rate for various needle lifts. Usually, the fouling values are compared at a needle lift of 0.1 mm since they are more discriminating and more precise and repeatable (repeatability <5%). The change in loss of flow rate before/after the test makes it possible to deduce the percentage loss of flow rate. Taking into account the repeatability of the test, a significant detergent effect can be asserted for a reduction in the loss of flow rate, i.e. a gain in flow rate of greater than 10 points (>10%).

The results obtained are collated in the table below:

| | Rate of | Loss of flow |
|---|---|---|
| Additive | treatment | rate (%) |
| 40% quaternized EHMA/DMAEMA | 50 ppm | 3.1% |
| block copolymer | | |

The above results show that, at a very low rate of treatment of 50 ppm (50 mg/kg), the copolymer according to the invention leads to excellent detergency results (“keep-clean” effect) since the loss of flow rate is insignificant (less than 10%).

The above copolymer is also useful as a demulsifying additive.

1. A copolymer comprising:
at least one unit of formula (I) below: 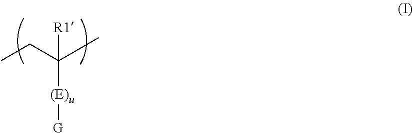
in which
u=0 or 1,
R₁′ represents a hydrogen atom or a methyl group,
E represents —O— or —N(Z)—, or —O—CO—, or —CO— or —NH—CO— or —CO—NH—, with Z representing H or a C₁ to C₆ alkyl group,
G represents a group chosen from a C₁ to C₃₄ alkyl group, an aromatic nucleus, an aralkyl group comprising at least one aromatic nucleus and at least one C₁ to C₃₄ alkyl group, and
units of formula (II) below: 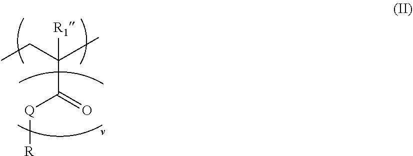
in which
v=0 or 1,
R₁″ is chosen from a hydrogen atom and a methyl group,
Q is chosen from an oxygen atom and a group —NR′— with R′ being chosen from a hydrogen atom and C₁ to C₁₂ hydrocarbon-based chains,
R represents a C₁ to C₃₄ hydrocarbon-based chain which may also contain one or more nitrogen and/or oxygen atoms and/or carbonyl groups, substituted with at least one non-quaternary amine group and/or at least one quaternary amine group,
said non-quaternary amine group comprising at least one primary, secondary or tertiary amine function,
said quaternary amine group comprising at least one quaternary ammonium function and optionally one or more hydroxyl groups,
5 mol % to 95 mol % of the groups R of the units of formula (II) comprising at least one quaternary amine group.

2. (canceled)

3. The copolymer of claim 1, in which the group R of formula (II) comprising at least one non-quaternary amine group is represented:
when v is equal to 1, by formula (V):
L-R′₂— (V)
when v is equal to 0, by formula (V) or formula (V′):
L-R′₂— (V)
L- (V′)
in which formulae (V) and (V′):
R₂′ is chosen from C₁ to C₃₄ hydrocarbon-based chains, optionally substituted with at least one hydroxyl group, and
L is chosen from the group consisting of:
the following groups:
amine: —NH₂; —NHRₐ; —NRₐR_{b};
imine: —HC═NH; —HC═NRₐ; —N═CH₂; N═CRₐH; —N═CRₐR_{b};
amidine: —(C═NH)—NH₂; —(C═NH)—NRₐH; —(C═NH)—NRₐR_{b}; —(C═NRₐ)—NH₂; —(C═NRₐ)—NR_{b}H; —(C═NRₐ)—NR_{b}R_{c}; —N═CH(NH₂); —N═CRₐ (NH₂); —N═CH(NRₐH); —N═CRₐ(NRₐH); —N═CH(NRₐR_{b}); —N═CRₐ (NR_{b}R_{c});
guanidine: —N═C(NH₂)₂; —N═C(NRₐH)₂; —N═C(NRₐR_{b})₂; —N═C(NRₐH)(NR_{b}H);
aminoguanidine: —NH—(C═NH)—NH—NH₂; —NH—(C═NH)—NH—NHRₐ; —N═C(NH₂)(NH—NH₂); —N═C(NRₐH)—NH—(C═NH)—NH₂; —N═C(NRₐH)—NH—(C═NR_{b})—NH₂; —N═C(NRₐR_{b})(NH—NH₂); —N═C(NRₐR_{b}) (NRₐ—NH₂;
biguanidine: —NH—(C═NH)—NH—(C═NH)—NH₂; —NH—(C═NH)—NH—(C═NH)—NHRₐ; —N═C(NH₂)—NH—(C═NH)—NH₂; —N═C(NH₂)—NH—(C═NRₐ)—NH₂; —N═C(NH₂)—NH—(C═NH)—NRₐH; —N═C(NH₂)—NH—(C═NRₐ)—NR_{b}H; —N═C(NH₂)—NH—(C═NH)—NRₐR_{b}; —N═C(NH₂)—NH—(C═NRₐ)—NR_{b}R_{c}; —N═C(NRₐH)—NH—(C═NH)—NH₂; —N═C(NRₐH)—NH—(C═NR_{b})—NH₂; —N═C(NRₐH)—NH—(C═NH)—NR_{b}H; —N═C(NRₐH)—NH—(C═NR_{b})—NR_{c}H; —N═C(NRₐH)—NH—(C═NH)—NR_{b}R_{c}; —N═C(NRₐH)—NH—(C═NR_{b})—NR_{c}R_{d}; —N═C(NRₐR_{b})—NH—(C═NH)—NH₂; —N═C(NRₐR_{b})—NH—(C═NR_{c})—NH₂; —N═C(NRₐR_{b})—NH—(C═NH)—NR_{c}H; —N═C(NRₐR_{b})—NH—(C═NR_{c})—NR_{d}H; —N═C(NRₐR_{b})—NH—(C═NH)—NR_{c}R_{d}; —N═C(NRₐR_{b})—NH—(C═NR_{c})—NR_{d}Rₑ; and
polyamine and polyalkylene-polyamine groups, notably those of formulae —NH—(R_{f}—NH)ₖ—H; —NH—(R_{f}—NH)ₖ— Rₐ;
with Rₐ, R_{b}, R_{c}, R_{d} and Rₑ representing, independently of each other, a C₁-C₃₄ and preferably C₁-C₁₂ alkyl group, optionally comprising one or more NH₂ functions and one or more —NH— bridges;
R_{f} represents a C₁-C₆ and preferably C₂-C₄ alkyl group, and k represents an integer ranging from 1 to 20 and preferably from 2 to 12.

4. The copolymer of claim 1, in which the group R of formula (II) comprising at least one quaternary amine group is a quaternized form of one of the groups of formulae (V) and (V′), these groups containing at least one quaternizable nitrogen atom, and preferably the quaternary amine group is obtained by partial quaternization of tertiary amine functions.

5. The copolymer of claim 1, in which the group R of formula (II) comprising at least one quaternary amine group is represented by one of the formulae (III) and (IV) below: 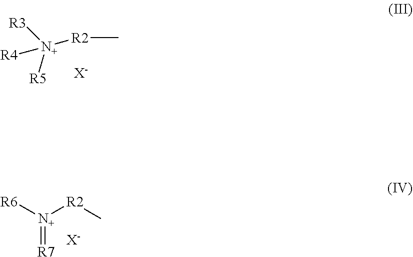
in which
X⁻ is chosen from hydroxide and halide ions and organic anions, preferably organic anions,
R₂ is chosen from C₁ to C₃₄ hydrocarbon-based chains, optionally substituted with at least one hydroxyl group,
R₃, R₄ and R₅ are identical or different and chosen independently from C₁ to C₁₈ hydrocarbon-based chains, it being understood that the groups R₃, R₄ and R₅ may contain one or more groups chosen from: a nitrogen atom, an oxygen atom and a carbonyl group and that the groups R₃, R₄ and R₅ may be connected together in pairs to form one or more rings,
R₆ and R₇ are identical or different and chosen independently from C₁ to C₁₈ hydrocarbon-based chains, it being understood that the groups R₆ and R₇ may contain one or more groups chosen from: a nitrogen atom, an oxygen atom and a carbonyl group and that the groups R₆ and R₇ may be connected together to form a ring.

6. The copolymer as claimed in claim 5, in which the group R of formula (II) comprising at least one quaternary amine group is represented by formula (III) in which:
X⁻ is chosen from organic anions, preferably conjugate bases of carboxylic acids,
R₂ is chosen from C₁ to C₃₄ hydrocarbon-based chains, preferably C₁ to C₁₈ alkyl groups,
R₃, R₄ and R₅ are identical or different and chosen independently from C₁ to C₁₈ hydrocarbon-based chains, optionally substituted with at least one hydroxyl group, it being understood that at least one of the groups R₃, R₄ and R₅ contains one or more hydroxyl groups.

7. The copolymer of claim 1, in which, in formula (I), the group G is a C₄ to C₃₄ alkyl.

8. The copolymer of claim 1, in which, in formula (I), R₁′ is a hydrogen atom.

9. (canceled)

10. (canceled)

11. The copolymer of claim 1, in which, in formula (I), the group E is chosen from: —CO—O— and —CO—NH—; preferably, the group E is a —CO—O— group, it being understood that the group E is connected to the vinyl carbon via the carbon atom.

12. The copolymer of claim 1, in which 10 mol % to 90 mol % of the groups R of the units of formula (II) comprise at least one quaternary amine group, preferably from 20% to 80%, more preferentially from 40% to 60% and better still from 45% to 55% relative to the total amount of the groups R of the units of formula (II).

13. The copolymer of claim 1, characterized in that it is chosen from block copolymers and statistical copolymers, and preferably the copolymer is a block copolymer.

14. (canceled)

15. The copolymer of claim 1, characterized in that it is a block copolymer comprising at least:
block A consists of a chain of structural units derived from a C₁-C₃₄ alkyl (meth)acrylate monomer, and
block B consists of a chain of structural units derived from alkyl (meth)acrylate or alkyl(meth)acrylamide monomers, of which 5 mol % to 95 mol % have an alkyl radical consisting of a C₁ to C₃₄ hydrocarbon-based chain substituted with a quaternary amine group and optionally one or more hydroxyl groups, and of which 5 mol % to 95 mol % have an alkyl radical consisting of a C₁ to C₃₄ hydrocarbon-based chain substituted with a non-quaternary amine group chosen from primary, secondary and tertiary amines, preferably tertiary amines.

16. (canceled)

17. (canceled)

18. A concentrate for fuel comprising one or more copolymers of claim 1, mixed with an organic liquid,
said organic liquid being inert with respect to said copolymer(s) and miscible with said fuel.

19. A fuel composition comprising:
(1) a fuel derived from one or more sources chosen from the group consisting of mineral, animal, plant and synthetic sources, and
(2) one or more copolymers of claim 1.

20. The fuel composition as claimed in claim 19, characterized in that it comprises said copolymer(s) in a total content of at least 5 ppm by weight, preferably at least 10 ppm, more preferentially in a content of from 10 to 5000 ppm, even more preferentially from 20 to 2000 ppm and better still from 50 to 1000 ppm.

21. (canceled)

22. The fuel composition as claimed in claim 19, in which the hydrocarbon-based fuel is chosen from gasolines and gas oils.

23. The use of the copolymer of claim 1 as detergent additive in a liquid fuel for internal combustion engines, said fuel additive composition being used alone or in the form of a concentrate where the copolymer is mixed with an organic liquid, said organic liquid being inert with respect to said copolymer and miscible with said fuel.

24. (canceled)

25. (canceled)

26. The use of claim 23, in which the internal combustion engine is a diesel engine, preferably a direct-injection diesel engine.

27. The use as claimed in claim 26, for preventing and/or reducing the formation of deposits in the injection system of a diesel engine.

28. The use of the copolymer of claim 1, as demulsifying additive in a liquid fuel for internal combustion engines, said fuel additive composition being used alone or in the form of a concentrate where the copolymer is mixed with an organic liquid, said organic liquid being inert with respect to said copolymer and miscible with said fuel.

29. A process for keeping clean and/or for cleaning at least one of the internal parts of an internal combustion engine, comprising at least the following steps:
the preparation of a fuel composition by supplementing a fuel with one or more copolymers of claim 1 or with a concentrate where the copolymer is mixed with an organic liquid, said organic liquid being inert with respect to said copolymer and miscible with said fuel, and then
the combustion of said fuel composition in said internal combustion engine.

30. (canceled)
